(19) United States
(12) Patent Application Publication
(10) Pub. No.: US 2020/0201294 A1
(43) Pub. Date: Jun. 25, 2020

(54) SYSTEM AND METHOD FOR AGGREGATION AND DISAGGREGATION OF DIGITAL ASSETS

(71) Applicant: LEO LANE LTD., Tel Aviv (IL)

(72) Inventors: Lee-Bath NELSON, Raanana (IL); Moshe MOLCHO, Raanana (IL); Shmuel KORENBLIT, Ganei Tikva (IL); Tom NAHUM, Tel Aviv (IL); David SAAR, Netanya (IL)

(73) Assignee: LEO LANE LTD., Tel Aviv (IL)

(21) Appl. No.: 16/718,331

(22) Filed: Dec. 18, 2019

Related U.S. Application Data
(60) Provisional application No. 62/784,743, filed on Dec. 25, 2018.

(51) Int. Cl. G05B 19/418; G06F 21/60; H04L 9/32

(52) U.S. Cl. CPC G05B 19/4183; G06F 21/602; G05B 2219/35134; G05B 2219/36542; H04L 9/3213

(57) ABSTRACT

A system and method for controlling manufacturing of items may include encrypting content in at least one LEO file and associating at least one LEO token with at least one LEO file, wherein a LEO file includes at least one three-dimensional (3D) design representation of an item. A first GREG file may be created based on information in at least one of: a LEO file or a previously existing, second GREG file. A GREG token may be associated with the first GREG file and with at least one of: the at least one LEO token and a second GREG token. The GREG token may be used to enable at least one of: (a) a manufacturing device to perform one or more manufacturing steps for an item and (b) a software program to perform a manufacturing step related to at least one representation of an item.

### CROSS-REFERENCE TO RELATED APPLICATIONS

This application claims the benefit of U.S. Provisional Patent Application No. 62/784,743, entitled “SYSTEM AND METHOD FOR AGGREGATION AND DISAGGREGATION OF DIGITAL ASSETS”, filed on Dec. 25, 2018, which is incorporated herein by reference in its entirety.

### FIELD OF THE INVENTION

The present invention is in the field of production of items. In particular, the present invention is directed to aggregation and disaggregation of digital assets and/or aggregation and disaggregation of metadata related to digital assets.

### BACKGROUND

Three dimensional (3D) printing is a fast growing field that enables the manufacturing of items to be on demand and close to the customer. Companies that create 3D printable parts and products manufacture them in-house or externally at a service provider. In addition, often different unrelated parts, e.g. from different users or parties, may be printed together in the same printer run (e.g. at the same time, on the same printer bed, in the same print batch).

### SUMMARY

A system and method for controlling manufacturing of items may include encrypting content or data in at least one limited edition object (LEO) file and adding to or associating at least one LEO token with at least one LEO file, wherein a LEO file includes at least one three-dimensional (3D) design representation of an item; creating a first aggregated (GREG) file based on information in at least one of: a LEO file or a previously existing GREG file; adding to or associating at least one aggregated (GREG) token with the GREG file and with at least one of: the at least one LEO token and a second GREG token; and using at least one GREG token, by a server, to enable at least one of: (a) a manufacturing device to perform one or more manufacturing steps for an item and (b) a software program to perform a manufacturing step related to at least one representation of an item or metadata associated with at least one item. Generally, associating a GREG file with content and/or a token may be, or may include, actually including the content or token in the GREG file, additionally, associating a GREG file with content and/or a token may be, or may include using a reference as further described, e.g., a token in a GREG file is used as reference (and to retrieve) data of a LEO file. Accordingly, where applicable, the terms “associating” and “including” as referred to herein may mean the same thing and may be used interchangeably herein, for example, including a LEO file in a GREG file may mean associating the LEO file with the GREG file.

A system and method may include determining, based on the at least one GREG token, a respective set of design characteristics of a respective set of items; and determining whether or not a manufacturing step can be performed for the entire set of items. A method may include receiving a definition of a manufacturing step; and identifying a group of items that can be processed together by the manufacturing step.

A system and method may include creating, based on a first GREG file or a LEO file, a second GREG file, the second GREG file including at least one representation of at least one item represented in the first GREG file. A method may include modifying the GREG file based on information associated with at least one of: a LEO file and a GREG file. A method may include removing, from the GREG file, information related to at least one of: a LEO file associated with this GREG file and another GREG file associated with this GREG file. A system and method may include recording information related to usage of data associated with the GREG file; and associating the recorded information with the GREG token or GREG file.

A GREG token may be used for retrieving, from a storage device, at least one of: a LEO token and a second GREG token. A GREG token may be used for at least one of: selecting, enabling and controlling at least one of: a pre-processing process step, a manufacturing (e.g., 3D printing) process step, and a post-manufacturing process step. A GREG token may be used for controlling the number of item copies manufactured. A GREG file may include unprotected information.

A system and method for controlling manufacturing of one or more items may include providing, for example, by a designer's computer, a first 3D design representation, the first 3D design representation usable by a manufacturing device for manufacturing the one or more products or items; encrypting the first 3D design representation to produce an encrypted 3D design representation; associating a set of tokens with the encrypted 3D design representation and providing the encrypted 3D design representation either to a manufacturing device or to a manufacturer computer. A method may include obtaining a token and including the token in a request to manufacture the items; using the token to determine whether or not to provide a decryption key; and, if determining to provide the decryption key, providing the decryption key and using the decryption key to produce a second 3D design representation, the second 3D design representation usable by a manufacturing device for manufacturing the items.

Current systems and method do not enable aggregation and disaggregation of 3D printable digital assets while providing the product owners appropriate and compatible quality and quantity control on their parts that are to be 3D printed together (e.g. in one print bed) or a part 3D printed with other parts from other owners while maintaining manufacturing restrictions, intellectual property (IP) protections for each part, and quantity control for each part. Current systems and methods further fail to enable a 3D printable file that includes permissions for multiple (possibly different) 3D printed instances to be split and be 3D printed in more than one printer run.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a system according to embodiments of the invention;

FIG. 2 shows a system according to embodiments of the invention;

FIG. 3 is a flowchart diagram of a method according to some embodiments of the present invention;

FIG. 4 is a flowchart diagram of a method according to some embodiments of the present invention;

FIG. 5 is a flowchart diagram of a method according to some embodiments of the present invention;

FIG. 6 is a flowchart diagram of a method according to some embodiments of the present invention;

FIG. 7 shows a block diagram of a computing device according to embodiments of the present invention;

FIG. 8A shows a block diagram of a digital object according to embodiments of the present invention;

FIG. 8B shows a system according to embodiments of the present invention;

FIG. 9 shows objects and associations according to embodiments of the present invention;

FIG. 10 is a flowchart diagram of a method according to some embodiments of the present invention;

FIG. 11 is a flowchart diagram of a method according to some embodiments of the present invention; and

FIGS. 12A and 12B illustrate a state (in terms of associated tokens) of a set of GREG and LEO files and associated tokens before (FIG. 12A) and after (FIG. 12B) an automated replenishment procedure according to some embodiments of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Although embodiments of the invention are not limited in this regard, the term “set” when used herein may include one or more items.

Embodiments of the invention enable a designer to offer a design for sale and control the number of items that will be made based on the design. Embodiments of the invention enable a designer to control aspects such as which material will be used in producing an item based on their design, what type of system may be used etc. Embodiments of the invention enable a designer to control modifications that can be made to a design prior to using it for manufacturing an item

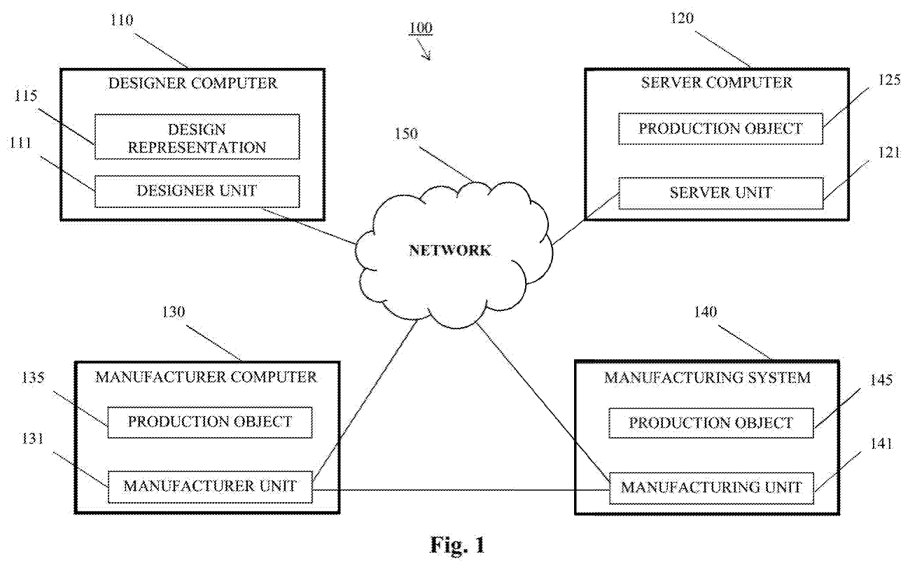

Reference is made to FIG. 1 that shows an exemplary system 100 according to embodiments of the invention. As shown, system 100 may include, or be connected to, a designer computer 110, a server computer 120, a manufacturer computer 130 and a manufacturing system 140. Designer computer 110, a server computer 120 and a manufacturer computer 130 may communicate over network 150. Network 150 may be any suitable network, e.g., the internet.

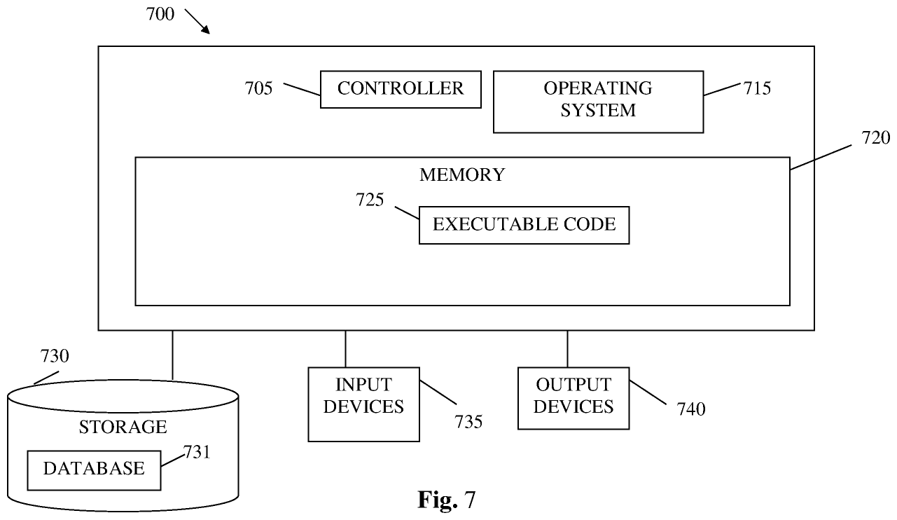

Designer computer 110 may be a home, personal or portable computer (PC) or it may be a computer in an organization. For example, designer computer 110 may include any components included in computing device 700 as described herein with reference to FIG. 7, e.g., a controller and a memory. Designer computer 110 may be used by a designer in order to produce or develop a representation of a design. For example, a user may use designer computer 110 to generate design representation 115. A design representation may be a digital representation of a product or item, usable for manufacturing the item. For example, using formats known in the art, a design representation may be a computer file that includes information usable by a 3D printer in order to make or produce an item.

For example, design representation 115 may be a file generated according to the STereoLithography (STL) format known in the art (also known as Standard Tessellation Language). Although STL is mainly referred to herein, other formats may be used without departing from the scope of the invention. Generally, a design representation may be generated according to any device independent format and may be further processed by a specific device in order to generate a specific format usable by the specific manufacturing or printing device. For example, a 3D printer may process an STL file to produce a gcode (also known as Gcode or G-Code) representation or file and use the gcode representation in order to manufacture or print an item. It will be understood that embodiments of the invention enable using any device independent format in order to generate a design representation (e.g., design representation 115).

Designer unit 111 may be any suitable unit that carries out methods or operations further described herein. For example, designer computer 110 may be, or may include, a controller similar to controller 705 and a memory similar to memory 720 that stores executable code similar to executable code 725 and designer unit 111 may be the controller, memory and code. In other embodiments, designer unit 111 may be, or may include, hardware, software, firmware or any combination thereof. For example, designer unit 111 may be a card or chip installed in designer computer 110. As shown, designer unit 111 may communicate with server unit 121 and with manufacturer unit 131 over network 150.

Server computer 120 may be any suitable server or computing device. For example, server computer 120 may include any components included in computing device 700, e.g., a controller and a memory. Server computer 120 may provide services as further described herein. As shown, server computer 120 may include a server unit 121. Server unit 121 may be any suitable unit that carries out methods or operations further described herein. For example, server unit 121 may be, or may include, a controller similar to controller 705 and a memory similar to memory 720 that stores executable code similar to executable code 725 and server unit 121 may be the combination of the controller, memory and code. In other embodiments, server unit 121 may be, or may include, hardware, software, firmware or any combination thereof. For example, server unit 121 may be a card or chip installed in server computer 120. As shown, server unit 121 may communicate with designer unit 111 and with manufacturer unit 131 over network 150.

As shown, server computer 120 may generate and store a production object 125. Although only one production objects 125 is shown it will be understood that any number of similar objects may be generated, stored, sent and received by server computer 120, manufacturer computer 130, manufacturing system 140 and/or designer computer 110. Production object 125 may include a design representation (e.g., one similar to design representation 115). Production object 125 may include an encrypted version of a design representation, for example, design representation 115 may be encrypted by server unit 121 to produce an encrypted design representation and the encrypted design representation may be included in production object 125. For example, production object 125 may be a file that includes an encrypted design representation. Production object 125 may include metadata related to a design representation. For example, a production object (e.g., any one of production objects 125, 135 and 145 described herein) may include tokens, decryption keys, requested modifications and/or permitted modifications as further described herein. For example, requested modifications and/or permitted modifications may include parameters related to a scale, color, texture or other common Computer-aided design (CAD) model attributes as known in the art.

As described herein, a production object or messages related to manufacturing an item may include metadata. For example, capabilities or limitations related to a manufacturing device or limitations dictated by an owner or operator of a manufacturing device may by included in a production object or in messages related to manufacturing an item as described herein. For example, an owner or operator of a manufacturing device may indicate a desired or maximal size of the object to be made, a time constraint and the like.

Manufacturer computer 130 may be any suitable server or computing device. For example, manufacturing computer 130 may include any components included in computing device 700, e.g., a controller and a memory. As shown, manufacturer computer 130 may be operatively connected to manufacturing system 140. For example, manufacturer computer 130 may be directly connected to manufacturing system 140 using a universal serial bus (USB) wire or using wireless network or technology, e.g., WiFi as known in the art. As shown, manufacturing system 140 may be connected to network 150 and communicate with manufacturer computer 130, server computer 120 and/or designer computer 110 over network 150. Accordingly, it will be understood that manufacturing unit 141 may communicate with any other component of system 100 either via manufacturer unit 131 or directly through network 150.

As shown, manufacturer computer 130 may store a production object 135. For example, in response to a request to manufacture an item sent by manufacturer computer 130, server computer 120 may provide manufacturer computer 130 with production object 135 that may include a digital design representation of an item usable by manufacturing system 140 in order to manufacture the item. Production object 135 (and production object 145 described herein) may include a decryption key for decrypting an encrypted design, tokens usable for determining the number of items that can be produced and various attributes of the produced items, e.g., color, material and/or modifications that can be applied to an original design.

A token as discussed herein may be for example a data object which may include, or be associated with as described herein, for example information regarding permission (e.g. who is permitted to print or manufacture an object), number of copies of an object allowed to be printed, printing requirement (e.g. temperature or temperature ranges the object should be printed at, accepted or required print materials), and/or other information.

As shown, manufacturing computer 130 may include a manufacturer unit 131. Manufacturer computer 130 may be any suitable unit that carries out methods or operations further described herein. For example, manufacturer computer 130 may be, or may include, a controller similar to controller 705 and a memory similar to memory 720 that stores executable code similar to executable code 725 and manufacturer unit 131 may be the combination of the controller, memory and code. In other embodiments, manufacturer unit 131 may be, or may include, hardware, software, firmware or any combination thereof. For example, manufacturer unit 131 may be a card or chip installed in manufacturer computer 130. As shown, manufacturer computer 130 may communicate with server unit 121 and with designer unit 111 over network 150.

Manufacturing system or device 140 may be any suitable system or device usable for manufacturing, printing, producing or making items or objects based on a digital design representation, e.g., based on design representation 115. Although printing or making items using a 3D printer is mainly referred to herein it will be understood that embodiments of the invention may be applicable to manufacturing, printing, producing or making items using any suitable device or system. Accordingly, the terms “manufacturing an item”, “production step”, “printing an item”, “producing an item” and “making an item” may be used herein interchangeably. For example, manufacturing system 140 may be a home 3D printer used by a private individual, it may be a CNC machine operated by an organization or a production plant or any other computer-aided manufacturing system. It will be understood that the scope of the invention is not limited by the type of manufacturing system 140. As shown, manufacturing system 140 may receive and store a production object 145 that may include any data as described with reference to production object 135 as well as additional data or parameters. It will be noted that production object 125 may be, or may include elements or data different from production object 135 and/or production object 145. For example, production object 125 may include an encrypted version of design representation 115 and tokens, production object 135 may include an encrypted version of design representation 115 and a decryption key and production object 145 may include a decrypted version of design representation 115, e.g., the original design representation 115 as generated by a user on designer computer 110. In other scenarios, production object 145 may include a decrypted modified version of design representation 115, e.g., the result of applying modifications to the original design representation 115.

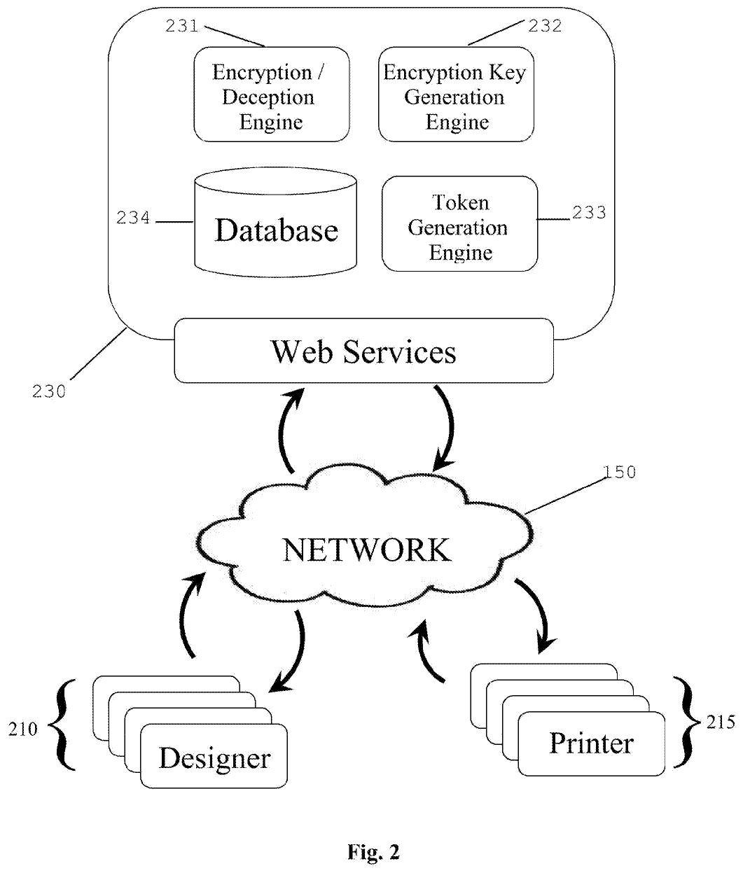

System 100 may enable controlling manufacturing of an item using web services. Reference is made to FIG. 2 that shows an exemplary system according to embodiments of the invention. As shown, designer computing devices 210 and 3D manufacturing units (e.g printers 215) may interact with web services 230 over network 150. For example, designer devices 210 may be a plurality of designer computers 110 and printers 215 may be a plurality of manufacturing systems 140. Web services 230 may be provided by one or more server computers 120. For example, server unit 121 may include an encryption/decryption engine or unit 231, a key generation engine or unit 232 and a token generation engine or unit 233. As referred to herein (and as known in the art), an encryption key may be used for both encrypting and decrypting information, the terms “encryption key” and “decryption key” may be used herein interchangeably. Server computer 120 may include a database 234 or other storage system and server unit 121 may store in database 234 any information, e.g., tokens, decryption keys, tables used for token management, production objects etc. As further described herein, using web service 230, a designer may sell, distribute or provide designs he or she produces and clients, customers or users may use web services 230 in order to purchase and/or obtain the designs and manufacture or make items according to the designs, e.g., using 3D printers 215.

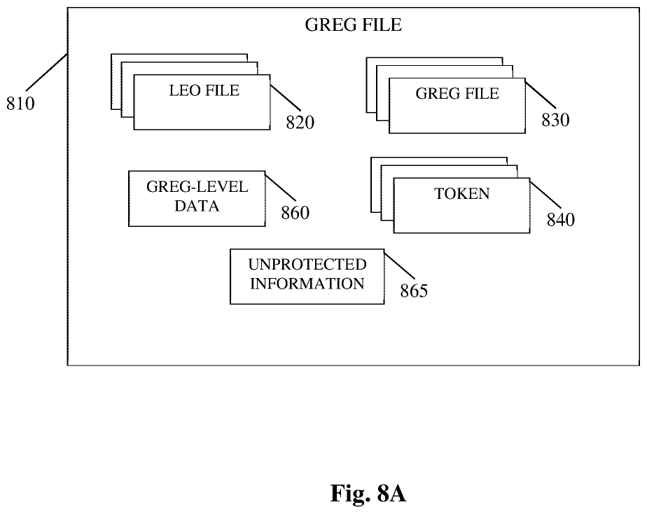

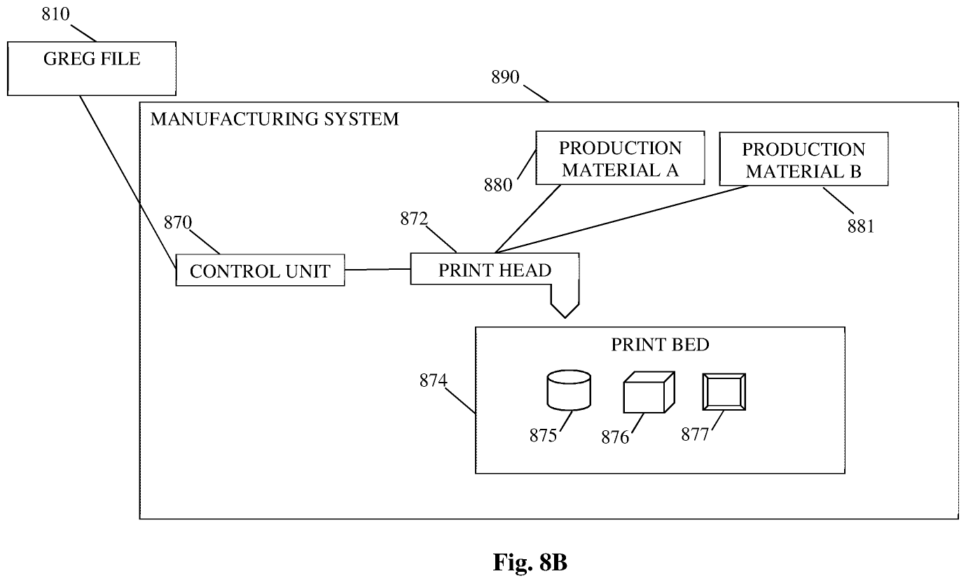

A printer 215, or a manufacturing system, e.g. manufacturing system 890 in FIG. 8B, may manufacture one or more objects based on one or more designs, by for example applying material (e.g. Plastic, Metal etc.) using an application device (e.g. an ink jet or another device) on a platform or bed. Alternatively, or additionally, a 3rd party may use web service 230 to sell, distribute or provide designs, e.g., on behalf of a designer. Accordingly, embodiments of the invention may support a sale process while the actual sale may be done using any additional system or method, e.g., a system external to system 100.

Although web services are mainly referred to herein, other configurations are enabled by embodiments of the invention. For example, the engines and database shown included in web services 230 may be included in a server in an organization or even in a user or home computer. For example, a local server in an organization or designer computer 110 may carry out any operations described herein with reference to web services 230 and/or server 120.

Although messages exchanged over a network are mainly referred to herein, where applicable, other means for transferring data between components of system 100 may be used. For example, files containing digital design representations or any other data may be stored on a removable device (e.g. a USB device) and the removable device may be used in order to transfer data between components of a system. For example, a manufacturing device may be a simple 3D printer that is not connected to a network and a digital design representation (e.g., in a file) may be provided to the 3D printer using a USB stick or Secure Digital (SD) memory card or chip.

As referred to herein, a digital design representation (or design for short) may be or may include a set of instructions, values and parameters usable (e.g., by a 3D printer) for the construction, production or making of an object or a system. For example, design 115 may be generated by a designer using CAD software as known in the art. As described, a digital design representation may be generated according to any suitable format, e.g., a device independent format. As described, a manufacturing device may be adapted to transform or convert a digital design representation from one format or another. For example, manufacturing unit 141 and/or manufacturer unit 131 may transform a generic digital design representation included in an STL to a device specific digital design representation, e.g., generate a digital design representation using gcode, as is known in the art.

Although STL is mainly referred to herein, it will be understood that embodiments of the invention are not limited by the format according to which a digital representation of a design is generated, encrypted or communicated. For example, a digital representation of a design (that may be included in an STL file) may be based on American Standard Code for Information Interchange (ASCII), binary representations or both. Other 3D file formats may be used, e.g., OBJ, 3DM, sliced file format such as .gcode files or .sli or .amf formats as known in the art. Files or containers other than an STL may be used. It will be understood for the sake of clarity and simplicity, STL is mainly referred to herein and that any format and encryption scheme may be used to generate and/or encrypt a design according to embodiments of the invention and any container or file that includes a design may be used.

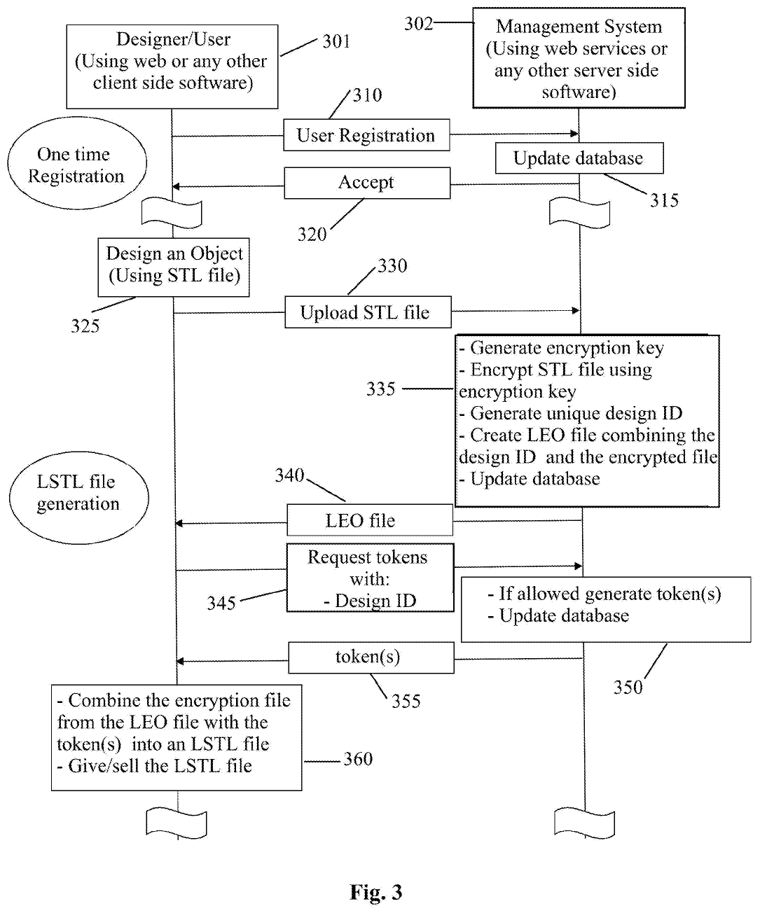

Reference is made to FIG. 3, which illustrates a flowchart diagram of a method according to some embodiments of the present invention. Typically, but not necessarily, the method or flow shown in FIG. 3 and described herein involves a designer or user as shown by block 301 and a management system or web service as shown by block 302. Generally, the term web service as referred to herein relates to a computer software function or service provided over a network, e.g., at a network address over the internet.

For example, in some embodiments, a management system as shown by block 302 is server unit 121, the designer as shown by block 301 is a user of user computer 110 and the user as shown by block 302 is a user of manufacturing computer 130.

Generally, a user as shown by block 301 may be any one of a designer, an operator of a marketplace, a buyer who pays for using a design and/or an owner of a manufacturing device. Of course, a designer may also be an owner of a manufacturing device. For example, a designer who uses designer computer 110 may also own and/or use manufacturing system 140. Similarly, a buyer may own or use manufacturing system 140. For example, in one scenario, designer unit 111 may generate and send messages as shown by blocks 310 and 330 and receive a message as shown by block 320, a computer operated by a provider of a marketplace may send and receive messages as shown by blocks 340 and 345 and 355 and a buyer may receive an LSTL file generated as shown by block 360. It will be understood that the roles assumed by entities such as a designer, a buyer and a marketplace are exemplary ones and other entities or roles may be contemplated without departing from the scope of the invention.

As shown by block 310, a flow may include user registration. For example, a designer that whishes to sell his designs over the internet may register or create an account in server 120, e.g., using web services 230 that may be provided by server 120. As shown by block 315, a database may be updated such the designer is recognized by a system in subsequent operations and events. For example, database 234 may be updated to include any information related to the designer as described herein, e.g., a unique designer identification (ID). As shown by block 320, an accept or acknowledge message may be sent back to the designer confirming the registration. For example, server unit 121 may inform designer unit 111 that a registration was successful and provide designer unit 111 with a designer ID. Designer unit 111 may include the designer ID in subsequent communications with any unit in system 100. Accordingly, a designer ID may be available to any unit in system 100.

As shown by block 325, a designer may generate a design of an object. For example, a designer may design a cup, a hat or any other object using a CAD application. The design (or digital representation of the design) may be generated, e.g., by the CAD application, according to any format, for example, the STL format may be used. AS shown by block 330, the design may be uploaded. For example, designer unit 111 may upload design 115 to server computer 120.

As shown by block 335, the uploaded design may be processed, metadata or other data may be generated and a production object may be generated. For example, and as shown, a unique design identification (ID) may be generated for the design. A unique design ID may unambiguously identify, or point to, one and only one specific design. A unique design ID may identify, or reference one or more parts of a design. For example, a design ID may identify or reference a number of parts related to a multi part object where each part of the multi part object may be manufactured separately. For example, a design may include a cup and saucer that may be manufactured separately and a unique design ID may reference both the cup and saucer.

As shown, an encryption key may be generated. For example, a unique encryption key may be generated for each design. As shown, the encryption key may be used to encrypt the uploaded design to produce an encrypted digital representation of the design (referred to herein as “encrypted design”). Any system or method may be used to encrypt or otherwise encode an original (e.g., uploaded) digital representation of a design such that the encryption key is required in order to produce or reproduce the original digital representation of the design from an encrypted digital representation of the design. For example, an encryption key may be a randomly generated number with 256, 512, 1024 or more bits. Any algorithm, system or method may be used to generate an encryption key and/or generate an encrypted design as described herein. For example, known in the art methods such as Rivest-Shamir-Adleman (RSA), Data Encryption Standard (DES) or Advanced Encryption Standard (AES) may be used.

As shown by block 335, a production object may be generated. For example, a production object may be, or may include, a LEO file. Generally, the term limited edition object (abbreviated LEO herein) reflects the fact that the number of actual, physical items that can be printed or manufactured based on a design representation in a LEO file is limited or controlled. A LEO file may include the design ID and the encrypted design. As further shown, a database may be updated, e.g., the encrypted design, encryption key, design ID and designer ID may be stored. Tables or lists may be updated in a database such that using a design ID, or designer ID any relevant data (e.g., the encrypted or original designs) may be found. Accordingly, it will be understood that any relevant information may be readily available to any component of system 100. For example, provided with a designer ID, any unit in system 100 may readily find all designs produced by the designer, a design ID may be used in order to obtain the digital representation of the design and so on.

In an embodiment, a server may store metadata related to a design but the actual digital design representation may not be stored on the server. For example, server unit 121 may store in database any information related to a design, e.g., design ID, designer restrictions or other metadata related to a design as described herein and may further store a reference or pointer to the actual digital design representation. For example, an internet protocol (IP) address of a computer that stores the actual digital design representation may be stored such that server unit 121 may enable obtaining the actual digital design representation. For example, the digital design representation (e.g., as generated by a designer and/or in encrypted format) may be stored on designer computer 110 and provided to buyers or to a market place from designer computer 110.

As shown by block 340, a production object, for example, a LEO file as shown, may be provided. Server unit 121 may provide a LEO file to any unit in system 100. For example, manufacturer unit 131 may receive a LEO file from server unit 120 and use the LEO file in order to manufacture an item or object based on the design in the LEO file. Since the design included in the LEO file is encrypted, a further operation or step may be required in order to use the LEO file.

A LEO file may be used, e.g., in a web site, in order to sell designs. For example, a LEO file may include an image of an object or item, e.g., provided by a designer. An internet site (web site) may receive from server computer 120 a plurality of LEO files, extract images of designs from the LEO files and present images. Design IDs may be extracted from the LEO files and may be shown for each design image. The design IDs may be accessible to, or obtained by, users who visit the web site.

A system and method according to embodiments of the invention combine the use of encryption keys and tokens in order to control and/or manage manufacturing of an item. As shown by block 345, a method or flow may include a request for a token. A request for a token may include a design ID. For example, designer unit 111 (or a computer supporting a marketplace) may extract a design ID from production objects 125 and include it in a request for a token sent to server unit 121.

As shown by block 350, a method or flow may include determining whether or not to provide a token. For example, a designer may instruct a web site to only enable 10 items to be manufactured based on a specific design. A web site may limit the number of items made by setting a threshold for providing tokens (e.g., 10 in the above example). For example, upon receiving a request for a token as shown by block 345, server unit 121 may use the included design ID to examine a table in database 234 and determine whether or not to provide a token. If it is determined to provide a token then a token may be provided as shown by block 355. A message that includes a token as shown by block 355 may include a token or other metadata. If it is determined not to provide a token then various actions may be performed. For example, server unit 121 may alert a management unit that requests for unavailable items were received; a message may be presented or sent to a client or customer who was denied a token, etc.

The number of tokens provided as shown by block 355 may vary. For example, a request for tokens as shown by block 345 may be for seven (“7”) tokens, but a threshold of five (“5”) tokens may be set for the relevant design ID. In such case, sever unit 121 may only return five (“5”) tokens. As further described herein, a unit may send a request to be informed how many tokens are available for an indicated design (e.g., indicated using the design's ID) and a server may respond to the request by providing the number of available tokens.

As shown by block 350, a database may be updated. For example, if it is indicated in the database that a limited number of tokens are to be provided to enable production or sell of a design then the number may be decreased by the number of tokens provided as shown by block 355. It will be understood that any number of tokens may be requested as shown by block 345 and any number of tokens may be provided as shown by block 355. Any calculation or algorithm may be used in determining whether or not to provide tokens as shown by block 350.

For example, server unit 121 may determine whether or not to provide tokens based on restrictions or criteria dictated or provided by a designer. For example, a designer may indicate a total or maximum allowed number of copies or objects that may be made based on a design and server unit 121 may only provide tokens if the number of copies already made based on the design is below the indicated number. Any other rules, restrictions, limitations or criteria may be used in determining whether or not to provide a token. For example, a rule or restriction may limit the number of objects that may be manufactured by a single user or buyer, or a threshold may limit the number of objects produced in a specific geographical area or country and so on.

As shown by block 360, an encrypted design (e.g., extracted from the LEO file provided as shown in block 340) and one or more tokens (e.g., received as shown by block 355) may be included in a production object also referred to herein as a LEO STL, or LSTL. The LSTL file may be sold or provided and used, e.g., as further described herein.

As described, an LSTL file may be stored on a server, e.g., in database 234 on server 120. In other embodiments, a server may store metadata related to a design and an LSTL file containing an encrypted digital representation of the design may be stored elsewhere, e.g., on a computer owned or operated by a designer, e.g., on designer computer 110.

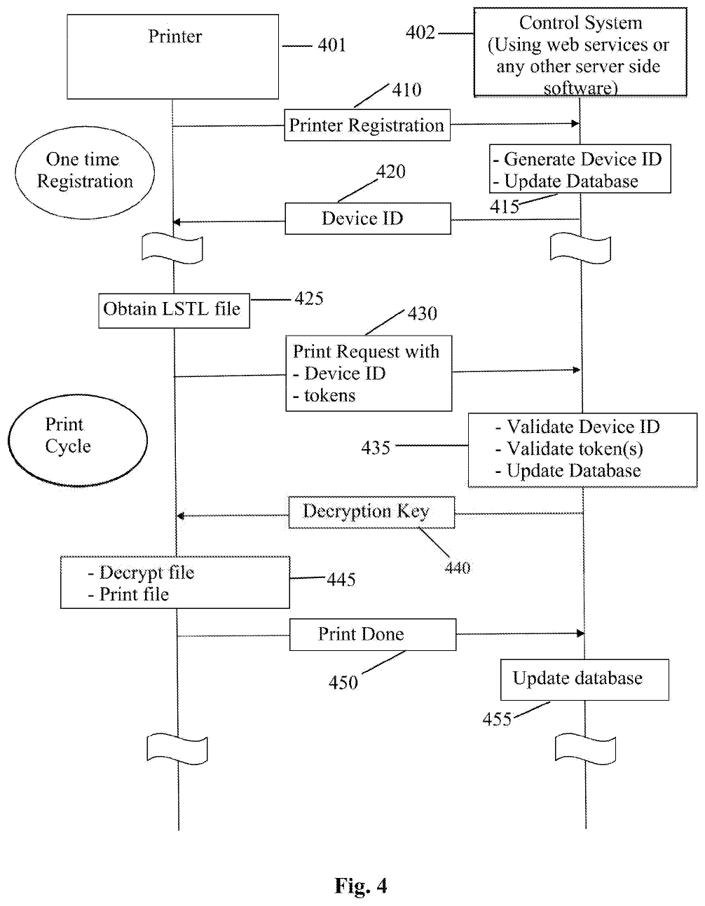

Reference is made to FIG. 4, a flowchart diagram of a method according to some embodiments of the present invention. Typically, but not necessarily, the method or flow shown in FIG. 4 and described herein involves a printer as shown by block 401 that may be manufacturing system 140 including manufacturing unit 141. A printer as shown by block 401 may be a system that includes both manufacturing computer 130 and manufacturing system 140. The method or flow shown in FIG. 4 and described herein may involve a management system as shown by block 402 that may be server unit 121.

As shown by block 410, the flow may include a registration of a printer. For example, manufacturing unit 141 sends a request to server unit 121. A request to register may include any data information or metadata. For example, in a request to register as shown by block 410, manufacturing unit 141 may include or indicate any attributes, description or properties of manufacturing system 140. For example, metadata provided by manufacturing unit 141 may include a model number or commercial name, a type etc. Metadata provided by manufacturing unit 141 may include a list of the materials that manufacturing unit 141 can use to manufacture items (e.g., Plastic and Aluminum), colors manufacturing unit 141 can use, etc. Other information in metadata provided by a manufacturing system may include restrictions or limitations, e.g., a minimal/maximal size of items that can be manufactured, a time period during which the manufacturing system can manufacture items etc.

Either in a message sent as shown by block 410 or in a separate message (not shown), characteristics or attributes of a manufacturing device may be provided. For example, capabilities or limitations of manufacturing system 140, e.g., supported scaling factors or object sizes, supported colors, or other common Computer-aided design (CAD) model attributes as known in the art may be provided to server unit 121 during a registration process.

User restrictions or limitations may be included in a device registration message or process. For example, even though a manufacturing device is capable of manufacturing objects in blue, green and red, an owner of the manufacturing device may want the manufacturing device to only manufacture green objects. In such case, user restrictions or limitations (e.g., included in a message sent as shown by block 410) may indicate that only green objects can be manufactured by the relevant device. As further described herein, controlling the manufacturing of an item may include determining whether or not to provide a token or decryption key based on user restrictions or constraints, characteristics or attributes of a manufacturing device and characteristics or limitations provided by a designer. For example, manufacturing of an item may be enabled if user and manufacturing device restrictions or constraints do not conflict with limitations or constraints indicated by a designer of the item.

As shown by block 415, the flow may include generating a device ID. For example, a unique ID may be generated as known in the art such a given device ID is associated with a single manufacturing device. A database may be updated. For example, server unit 121 may store the generated device ID and any relevant metadata, e.g., metadata received from manufacturing unit 141 as shown by block 410. Accordingly, using a unique device ID associated with a manufacturing device, attributes or any other metadata related to the manufacturing device may be obtained. For example, server unit 121 may store metadata of a device in database 234 and the information may then be extracted from database 234.

As shown by block 420, the flow may include providing a device ID. For example, server unit 121 sends a device ID to manufacturing unit 141 or to manufacturer unit 131.

As shown by block 425, the flow may include obtaining a production object. For example, the LSTL file produced as shown by block 360 in FIG. 3 may be provided by server unit 121 to manufacturing unit 141 or to manufacturer unit 131.

As shown by block 430, the flow may include requesting to manufacture an item. For example, a request sent as shown by block 430 may be a request to print in the case where manufacturing system 140 is a 3D printer. As shown, a request to manufacture or make an item may include one or more tokens and a device ID. A request to manufacture, make or print may include any metadata. For example, requested modifications to an original design of an item may be included in a request to manufacture an item. For example, provided with an LSTL file, manufacturing unit 141 may extract one or more tokens from the LSTL file and include the tokens and its device ID (e.g., provided as shown by block 420) in a request to manufacture or print an item based on a design in the LSTL file.

As shown by block 435, the flow may include validating the device ID, validating received tokens and/or updating a database. For example, server unit 121 may receive a device ID, tokens and metadata from manufacturing unit 141 and may determine whether or not to provide a decryption key based on the received device ID, received tokens and received metadata. For example, as described herein, the number of items manufactured based on a design may be controlled based on tokens provided and a threshold. Accordingly, a decryption key may only be provided if the number of items already made does not exceed a threshold. A decryption key may only be provided if the tokens received are validated. For example, server unit 121 may record in database 234 the tokens provided for a specific design and, when tokens are received with a request to manufacture an item as shown by block 430, server unit may validate the received tokens were indeed provided for the requested item design.

A system and/or method according to embodiments of the invention may enable manufacturing of an item based on a token as described herein. Although enabling a user or device to manufacture an item by providing a decryption key is mainly discussed herein, other methods may be used by systems according to embodiments of the invention. For example, encrypting a design as shown by block 335 may include any transformation or processing of a design to produce a processed object and the processed object may be provided as shown by block 340. In order to enable manufacturing of an item, an executable code (e.g., an application) may be provided. For example, an application configured to produce an original design from a processed object may be provided, e.g., instead of providing a decryption key as shown by block 440. Accordingly, to enable manufacturing an item, a system or method according to embodiments of the invention may not necessarily use a decryption key. For example, instead of providing a decryption key, an application that produces a design representation usable by a manufacturing device for manufacturing the item from a processed object may be provided, e.g., by server unit 121.

In other embodiments, enabling to manufacture an item may include sending a message, e.g., a message that includes permission to manufacture or print. For example, production object 145 provided to manufacturing system 140 may include a design representation usable by manufacturing system 140 for manufacturing an item and manufacturing unit 141 may only cause manufacturing system 140 to manufacture the item if permission is received from server unit 121 or from manufacturer unit 131. For example, rather than enabling to manufacture an item by providing a decryption key as shown by block 440, a flow may include enabling to manufacture an item by sending a message informing a printer or manufacturing device that manufacturing an item is permitted.

Server unit 121 may examine attributes of the requesting (or target) manufacturing device and determine whether or not to provide a decryption key based on attributes, properties or other parameters related to the manufacturing device. For example, server unit 121 may examine properties, capabilities or attributes of a target manufacturing device (e.g., received as shown by block 410 and recorded or stored in database 234) and may determine, based on properties or attributes of the manufacturing device whether or not to provide a decryption key.

For example, a designer may specify a set of printer types or models that may print his or her design. Accordingly, if manufacturing system 140 is not a printer that is included in a set of printers defined by the designer, server unit may determine to prevent manufacturing system 140 from printing an item (e.g., by determining not to provide a decryption key).

If it is determined to provide a decryption key, the decryption key may be provided as shown by block 440. A message that includes a decryption (or encryption) key as shown by block 440 may include a design ID or other metadata. If it is determined not to provide a decryption (or encryption) key, then various actions may be performed. For example, server unit 121 may alert a management unit that requests to print were denied or refused, a message may be presented or sent to a client or customer who was denied a decryption (or encryption) key etc.

As shown by block 445, the flow may include using a decryption key to decrypt a file. For example, using a decryption key provided as shown by block 440, manufacturing unit 141 may decrypt an encrypted design in an LSTL file to produce an original or decrypted design and print or manufacture an item using the original or decrypted design. In an embodiment, an encrypted design may be decrypted and a representation of the design that is different from the original representation may be produced. For example, manufacturing unit 141 may decrypt an encrypted LSTL file or object and generate a gcode or other representation of the design. Accordingly, a first 3D design representation may be encrypted to produce an encrypted 3D design representation, e.g., by server unit 121 and the encrypted 3D design may be decrypted to produce a second 3D design representation that is different from the first 3D design representation.

As shown by block 450, the flow may include reporting to a management system upon completion of manufacturing an item. For example, manufacturing unit 141 may send a message to server unit 121 informing that a print was successfully completed or informing failure to print an item.

As shown by block 455, the flow may include updating a database. For example, server unit 121 may update any data or fields in database 234, e.g., decrease the number of tokens for a design, perform and record billing operations etc.

As described herein, in some embodiments, designs may be saved on a server (or in the cloud as referred to in the art). For example, design representations may be saved on server computer 120 that may be a web server. In other embodiments, other means or locations for saving or storing designs may be used. For example, server unit 121 may be included in designer computer 110 such that designer computer 110 may perform any operations described herein with reference or respect to server computer 120 and thus, systems and methods described herein may not necessarily include a web server or cloud storage. For example, including server unit 121, production object 125 may be generated and provided by, designer computer 110.

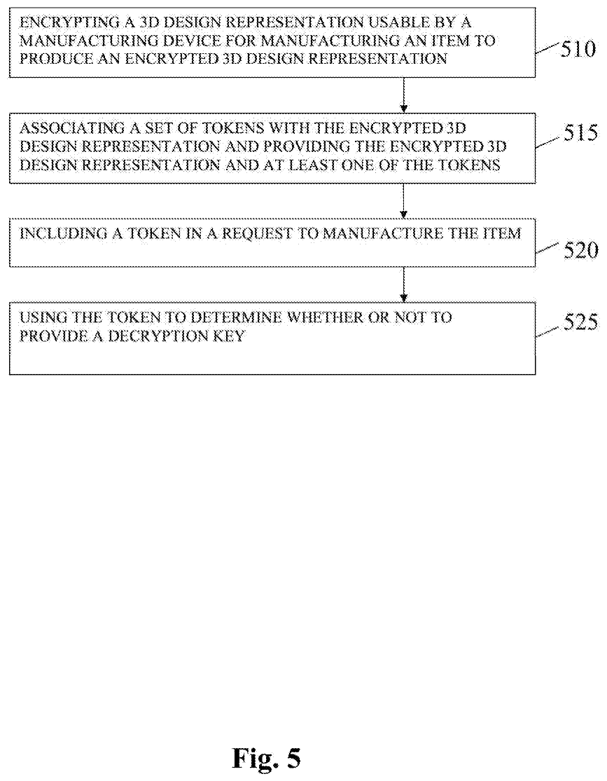

Reference is made to FIG. 5, a flowchart diagram of a method according to some embodiments of the present invention. As shown by block 510, the method or flow may include encrypting a 3D design representation usable by a manufacturing device for manufacturing an item to produce an encrypted 3D design representation.

For example, the flow may include providing (e.g., by a designer as described herein) a first 3D design representation, the first 3D design representation usable by a manufacturing device for manufacturing the item. As described, server unit 121 may receive the first 3D design representation and encrypt it to produce an encrypted 3D design representation.

As shown by block 515, the method or flow may include associating a set of tokens with the encrypted 3D design representation and providing the encrypted 3D design representation and at least one of the tokens. For example, server unit 121 may generate tokens as shown by block 350 in FIG. 3 and associate the tokens with a design provided by a designer.

As shown by block 520, the method or flow may include including a token in a request to manufacture the item. Server unit 121 may provide the tokens, e.g., in response to a request for tokens as shown by blocks 345 and 355 in FIG. 3. Accordingly, a method may include obtaining a token (e.g., by a client from server unit 121) and including the token in a request to manufacture the item (e.g., a request as shown by block 430 in FIG. 4).

As shown by block 525, the method or flow may include using the token to determine whether or not to provide a decryption key. As described herein, if determining to provide the decryption key, the flow may include using the provided decryption key to decrypt the encrypted design to produce a second 3D design representation, the second 3D design representation usable by a manufacturing device for manufacturing the item. It will be noted that a first representation of a design may be used to produce an encrypted design and decrypting the encrypted design may produce a second, different from the first, decrypted representation of the design.

Various deviations or additions to the flow shown in FIG. 5 may be contemplated. For example, manufacturing unit 141 may use a decryption key and an encrypted design to produce a representation of the design that is usable by manufacturing system 140 (e.g., a representation in a specific machine code) where the representation of the design produced by manufacturing unit 141 is different from the representation of the design as provided by a designer who created the design. The flow may further include manufacturing the item, by a manufacturing system, based on a decrypted design representation.

As described, a set of tokens and an encrypted design representation may be provided in a container file. For example, a container file may be an LSTL or other production object as described herein. Obtaining a token (e.g., by a manufacturing unit) may include extracting the token from the container file. For example, tokens may be extracted from LSTL files by manufacturer unit 131 or by manufacturing unit 141.

Obtaining a token may include requesting a token. For example, as shown by block 345, a token may be obtained by requesting a token. Tokens may be generated in advance, e.g., when encrypting a design as shown by block 335 or they may be generated in real-time, e.g., upon receiving a request for a token. For example, token generation engine 233 may generate tokens in real-time, upon receiving a request for tokens. For example, server unit 121 may cause token generation engine 233 to generate a specified number of tokens for a specific design.

The flow may include receiving a request that includes a token and/or a design ID, using the token and/or a design ID to determine a number of items that may be manufactured based on the design and providing the number of items that may be manufactured. For example, a user may wish to manufacture three (“3”) items based on a design. Prior to requesting to manufacture three (“3”) items, a user may wish to know how many items (e.g., duplicates) may be produced. The user may (e.g., using manufacturer unit 131) send a request to server unit 121 and server unit 121 may respond with the number of items that may be made.

For example, based on tokens already served, based on instructions received from the designer or based on any other considerations (e.g., as described herein) server unit 121 may determine that only two (“2”) items may be made by the requesting entity. Accordingly, in the above example, server unit 121 may inform, in a response that two (“2”) items may be made. The user can then use the number indicated by server unit 121 in a subsequent request to print.

A request may include the number of items to be manufactured and a response may include permission to manufacture as requested or permission to manufacture an indicated number of items. For example, based on user input or otherwise, manufacturer unit 131 or manufacturing unit 141 may determine that five items are to be made based on a design. Manufacturer unit 131 or by manufacturing unit 141 may obtain a token as described and send a message to server unit 121 the message including the token, a design ID and a request to manufacture five items. Server unit 121 may use the token in order to determine a number of items that may be manufactured and may respond with a permission to manufacture as requested or the response may indicate a different, e.g., smaller number of items that may be made.

For example, as described, by tracking tokens provided and used, server unit 121 may record, track or monitor the number of items already manufactured based on a design and may limit or control the number of additional items that will be made.

As described, a flow may include associating a design identification or a design ID with a 3D design representation, e.g., as shown in block 335 in FIG. 3. The flow may further include providing the design ID, e.g., in a LEO file as shown by block 340. A flow may include including the design identification in a request for one or more tokens, e.g., as shown by block 345, generating a set of tokens in response to the request (e.g., as shown by block 350). A flow may include including a set of tokens and an encrypted file in a container file, e.g., as shown by block 360.

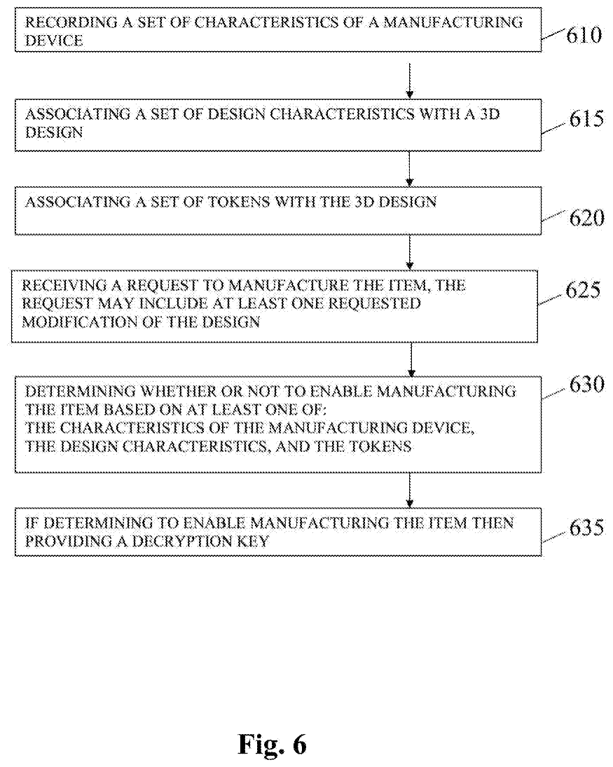

Reference is made to FIG. 6, a flowchart diagram of a method according to some embodiments of the present invention. As shown by block 610, the method or flow may include recording a set of characteristics of a manufacturing device. For example, a set of characteristics of a manufacturing device may be provided by manufacturer unit 131 or by manufacturing unit 141 that may include the set of characteristics in a request to register as shown by block 410. The set of characteristics may be recorded in database 234, e.g., as shown by block 415.

As shown by block 615, the method or flow may include associating a set of design characteristics with a 3D design. For example, a set of design characteristics, restrictions, allowed modifications or other constraints may be provided by a designer when providing the design, e.g., as shown by block 330. The set of design characteristics may be stored in association with the design or with a design ID. Accordingly, a system and method according to embodiments of the invention may control manufacturing of an item based on a set of design characteristics. Generally, a designer may indicate attributes of items made according to his or her design by providing a set of design characteristics. For example, a set of allowed or permitted colors, a maximal or minimal size or scale, a set of materials to use may all be indicated in a set of design characteristics. As described, a request to manufacture an item according to a design may be processed according to characteristics associated with a design, e.g., characteristics provided by a designer. A request to manufacture an item according to a design may be allowed or denied based on examining requested attributes or modifications and restrictions or characteristics associated with the design. For example, if a designer indicates (e.g., when uploading a design as shown by block 330 in FIG. 3) that an item according to his design is to be manufactured in blue, a request to manufacture the item in red (e.g., as shown by block 430 in FIG. 4) may be denied.

As shown by block 620, the method or flow may include associating a set of tokens with the 3D design. For example, tokens generated as shown by block 350 may be associated with a design using the design ID provided as shown by block 345. For example, server unit 121 may store tokens in database 234 such that they are associated with a specific design ID, e.g., as known in the art.

As shown by block 625, the method or flow may include receiving a request to manufacture the item, the request may include at least one requested modification of the design. For example, prior to sending a request to print as shown by block 430, a user may use any CAD or other software tool to examine and modify the design. For example, the size, scale or material used may be changed by a user and the user may produce a set of desired or requested modifications. The user may then include the set of desired or requested modifications in a request to print, e.g., as shown by block 430.

As shown by block 630, the method or flow may include determining whether or not to enable manufacturing the item based on at least one of: the characteristics of the manufacturing device, the design characteristics, and one or more tokens. Generally, enabling manufacturing of the item may be or may include providing a decryption key that may be used to decrypt an encrypted design.

Determining whether or not to enable manufacturing the item based on token logic or considerations may be done as described herein. Determining whether or not to enable manufacturing the item based on the characteristics of the manufacturing device and the design characteristics may be done by relating or comparing the design characteristics to the characteristics of the manufacturing device. For example, if the design characteristics indicate that the item is to be manufactured using plastic and the characteristics of the manufacturing device indicate that the device can only use silicon then server unit 121 may determine not to enable manufacturing the item, e.g., in such case, server unit 121 may not return a decryption key as shown by block 440 and may further generate an alert, email etc.

Various other flows or sub-flows may be realized according to embodiments of the invention. For example, a request to manufacture an item including a set of requested modifications may be received as described and the requested modifications may be analyzed e.g., with respect to design characteristics or restrictions provided by a designer as described.

Even if not all requested modifications are permitted, a decryption key may still be provided. For example, server unit 121 may receive a request that includes three (“3”) requested modifications, determine that only two of the requested modifications are permitted and return a decryption key and an indication of the two permitted modifications.

In another embodiment, server unit 121 may receive a request that includes a set of requested modifications, determine that only a sub-set of the set of requested modifications is permitted and return a response that lists or indicates the allowed or permitted sub-set of modifications. A user or unit may use the sub-set of allowed or permitted modifications in a subsequent request to print, e.g., as shown by block 430.

As shown by block 635, the method or flow may include, if determining to enable manufacturing the item, then providing a decryption key. For example, if token considerations or logic as described herein permits manufacturing of an item as requested and the set of requested modifications is permitted or authorized, e.g., by the designer, then server unit 121 may provide a decryption key as shown by block 440. Accordingly, a system or method according to embodiments may associate a set of design characteristics with a 3D design representation; receive a set of printer characteristics related to a printing device; and determine whether or not to provide a decryption key based on relating at least one of the set of design characteristics to at least one printer characteristic. A printing device may be any manufacturing device usable for manufacturing a 3D item or object based on a digital design or representation of the item or object.

Reference is made to FIG. 7, showing high level block diagram of an exemplary computing device 700 according to embodiments of the present invention. As shown, computing device 700 may include a controller 705 that may be, for example, a central processing unit processor (CPU), a chip or any suitable computing or computational device, an operating system 715, a memory 720, a storage 730, input devices 735 and output devices 740. A system for manufacturing an item according to embodiments of the invention may comprise more than one computing devices 700.

Operating system 715 may be or may include any code segment designed and/or configured to perform tasks involving coordination, scheduling, arbitration, supervising, controlling or otherwise managing operation of computing device 700, for example, scheduling execution of programs. Operating system 715 may be a commercial operating system. For example, in an embodiment, operating system 715 is the Windows operating system provided by Microsoft.

Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a non-transitory memory or other suitable memory units or storage units. In an embodiment, Memory 720 is a non-transitory processor-readable storage medium that stores instructions and the instructions are executed by controller 705. In an embodiment, when the instructions stored in one or more memories 720 are executed by one or more controllers 705 they cause the one or more controllers 705 to carry out methods described herein. For example, server 120 may be a device similar to computing device 700 and server unit 121 may be a controller, memory and executable code as shown in FIG. 7 and described herein. Designer computer 110 and manufacturer computer 130 may be similar to, or may include components of computing device 700. Accordingly, designer unit 111 and/or manufacturer unit 131 may be or may include a controller, a memory and a set of instructions or executable code. Manufacturing system 140 may include any components included in computing device 700. Accordingly, manufacturing unit 141 may be or may include a controller, a memory and a set of instructions or executable code.

Executable code 725 may be any executable code, e.g., an application, a program, a process, task or script. Executable code 725 may be executed by controller 705 possibly under control of operating system 715. For example, executable code 725 may be an application that performs methods described herein. For example, a plurality of executable code segments similar to executable code 725, when executed by a plurality of controllers similar to controller 705 may cause the controllers to carry out methods as shown by FIGS. 3, 4, 5 and 6 and described herein.

Where applicable, executable code 725 may carry out operations described herein in real-time. One or more computing devices 700 and executable code 725 may be configured to update, process and/or act upon information at the same rate the information, or a relevant event, are received. For example, generating tokens as described herein may be done in real-time, e.g., immediately upon receiving a request as described. One or more controllers or processors 705 may be configured to carry out methods as disclosed herein, for example by being connected to one or more memories 720 storing executable code 725.

Storage 730 may be or may include, for example, a hard disk drive, a CD-Recordable (CD-R) drive, a universal serial bus (USB) device, an SD memory card or other suitable removable and/or fixed storage unit. For example, database 234 may include a storage system such as storage 730. As shown, Storage system 730 may include a database 731 that may be used, for example, to store tokens, LEO files and other files or objects as described.

Input devices 735 may be or may include a mouse, a keyboard, a touch screen or pad or any suitable input device. Input devices 735 may include a network interface card (NIC) that enables computing device to communicate over a network, e.g., over network 150. For example, a NIC installed in computing device 700 may be used to send and receive messages as described with reference to FIGS. 3 and 4. Other input devices or components included in input devices 735 may be a touch screen or pad or components that enable voice control and/or interacting with computing device 700 using gestures, e.g., using a touch screen as known in the art. It will be recognized that any suitable number of input devices may be operatively connected to computing device 700 as shown by block 735. Output devices 740 may include one or more displays, speakers and/or any other suitable output devices. Output devices 740 may include a network interface card (NIC) that enables computing device to communicate over a network, e.g., over network 150. It will be recognized that any suitable number of output devices may be operatively connected to computing device 700 as shown by block 740. A unit or module as described herein may be or may include executable code 725 and controller 705. For example, methods described herein may be performed by computing device 700 and units adapted to control manufacturing of an item as described herein may be units that include executable code 725 and controller 705.

Embodiments of the invention may include an article such as a computer or processor non-transitory readable medium, or a computer or processor non-transitory storage medium, such as for example memory 720, a disk drive, or a flash memory, encoding, including or storing instructions, e.g., computer-executable instructions, which, when executed by a processor or controller (e.g., controller 705), carry out methods disclosed herein. For example, storage medium such as memory 720, computer-executable instructions such as executable code 725 and a controller such as controller 705.

A manufacturing system or device (e.g. a 3D printer) can manufacture (e.g., print) hundreds of items or objects in one, single run (e.g., same print platform or bed as referred to in the art). A manufacturing system can print or manufacture, in a single run, different items, e.g., 100 dolls and 200 stars can be printed on the same print bed, batch, print platform or assembly, in the same print run or process.

However, known systems and methods do not enable associating data of a set of (possibly different) 3D objects (or 3D items) with a data object which may represent print instructions for the physical 3D items or objects to be printed and/or aggregating data of a set of 3D objects (or 3D items) into a single data object to thus enable manufacturing the set of 3D objects (or 3D items) in a single, or same, run or production process. Aggregating data of different items in a single data object (e.g., a data object such as a file) or associating data of different 3D objects (or 3D items) with a data object (e.g., a token) is a desirable capability and/or feature for many technological fields, a capability known systems and methods cannot provide.

Typically, information related to 3D objects or 3D items (e.g., digital design representation or other content in a LEO file) may be used by a number of units and/or in a number of stages. For example, a preprocessing (pre-processing) unit may access data in a file describing an item and/or may modify data in the file, then a unit of a printer may access the file during printing and then a post-processing unit may use data in the file, e.g., to paint or dye an item, smooth an item, heat or cool an item or a printer bed including the item and so on. Of course, information related to 3D objects or 3D items (e.g., in a LEO file) may be used by a single unit in order to perform several steps, e.g., a unit may use data in a LEO file to perform several manufacturing steps as described herein.

In another aspect, a file including description of an item may be used for more than one purpose. For example, a file containing design data (e.g., design representation 115 and/or production objects 125, 135 and 145) may be used by a number of software units, e.g., a first software unit may use data in a LEO file to generate a 2D or 3D image to be used in an advertising campaign, a second unit may use information in the LEO file to generate a bill of material (BOM) for an item described in the LEO file and a third unit may use data in the LEO file to actually manufacture or print the item.

However, known systems and methods do not enable tracking and recording information related to access and/or usage of data in an object that includes data related to an item, e.g., known systems and methods do not enable: tracking and recording: which software unit opened a file that includes, or is associated with, a design description; which restrictions apply to the particular item; when, where and by who an encrypted design representation was decrypted; what information in the file was used for; when and where usage occurred and so on.

Known systems and methods further fail to enable disaggregation (or disassociation) of data of a set of items in an object (e.g., file) into two or more objects or files to thus enable manufacturing of the items independently and/or processing of data of a first item without accessing or possessing data of a second item.

In some embodiments, a system and/or method for controlling usage of digital assets may include encrypting content or data (e.g. a 3D printer specification describing one or more objects to be printed) in at least one LEO file and adding to or associating at least one LEO token with the LEO file. A LEO token may be a token as described herein and may be used to identify, locate or retrieve data in the associated LEO file as further described herein. As described, a LEO file may be any suitable object that includes at least one three dimensional (3D) design representation of an item or other information pertinent to the manufacturing of the item. Although a LEO file is mainly described herein (for the sake of simplicity) it will be understood that any file or object that includes digital information related to a 3D design as described herein may be used, e.g., a LEO file may be a file in a database (e.g., database 731) or a segment in memory 720 that includes, or is associated with, a 3D design representation 115 and/or one of production objects 125, 135 and 145 and/or a token.

A combined or aggregated file (e.g., a GREG file described herein) may be created based on information associated with, or in, another file describing print data for an object and/or another combined or aggregated file. For example, a first GREG file may be created based on information associated with, or in, a LEO file and/or based on information associated with, or in, a second GREG file, e.g., a new GREG file may be created based on one or more LEO files and/or based on one or more existing GREG files. The term “file” as used herein may be related to any suitable digital object. Files that are specifically “GREG” or “LEO” files are described by example only, and need not be used. Typically, a “GREG” file is a file which is an aggregation of data in one or more other files (e.g., a GREG file aggregates data in one or more GREG files and one or more LEO files) or a GREG file may be, or may include, an aggregation of information related to a number of 3D designs. In some embodiments, a GREG file may aggregate information of (or associated with) a single GREG file or of a single LEO file. As further described, a GREG file may be, or may include, data that is the result of disaggregating other GREG files.

Generally, a GREG file is an aggregation of LEO files, that is, a GREG file may include or be associated with any information in a number of LEO or GREG files (or it may even include the actual LEO or GREG files) such that the GREG file can be used, e.g., to manufacture items associated with a plurality of LEO or GREG files associated with (or aggregated by or included in) the GREG file. Creating a GREG file, e.g., from one or more LEO files and/or GREG files may include more than merely concatenating the one or more LEO files and/or GREG files into the GREG file, for example (e.g., as shown in FIG. 8 and described herein), a GREG file may include data such as GREG-level data 860 and a plurality of tokens, that is, a GREG file may include more information (or different information) with respect to the LEO and/or GREG files used for creating the GREG file. As further described, other or additional data may be included in, or associated with, a GREG file, e.g., unprotected information.

Some embodiments may associate an aggregated (GREG) token with a GREG file and with one or more LEO tokens. Some embodiments may associate a first GREG token with a second GREG token. For example, when a GREG file is created it (or its token) may be associated with one or more tokens of other GREG files and/or associated with one or more tokens of LEO files.

The term “associate” as used herein may relate to establishing any form of relevant connection, linkage or relation between GREG files, LEO files, and tokens. For example, associating a first token with a second token, e.g., associating a GREG token with a LEO token may include linking the two tokens such that given the GREG token, the LEO token can be retrieved from a database (e.g., from database 731). Various methods or techniques of associating tokens, GREG files and LEO files may be used, e.g., a hierarchical graph, directed graph or an acyclic graph, where nodes or vertices are, or represent, GREG files and LEO files and edges are, or represent, tokens may be used. Other methods may include database systems (e.g., database 731) that enable locating and retrieving a first token based on a second token, e.g., tables (e.g., where an association includes placing associated elements in the same row), pointers or linked lists in a database may be used.

Any relevant entity may be associated with any other relevant entity, e.g., a GREG file may be associated with a unique token, with a token of another GREG or LEO file, a token of a LEO file may be associated with a token of another LEO or GREG file and so on.

A token, or data or value included in a token may be unique within a system such that a token can be used to unambiguously identify at least one other token or one GREG file or LEO file. For example, a token may be a digital data object that may be, or may include, a value where the value included in a token is unique as described. A token may be unique within a specific instantiation of the invention, but not be unique when compared with the universe of data or values stored on all existing computer systems.

Using a GREG token of (associated with) a GREG file, some embodiments (e.g. Web services 230) may enable at a manufacturing device to perform one or more manufacturing steps for an item associated with the GREG file and/or Web services 230 may enable a unit (e.g., software program) to perform a manufacturing step related to the item. For example, a GREG token of a GREG file may be used to determine the number of items (associated with, or included in, the GREG file) that are permitted to be manufactured as described herein, e.g., with reference to controlling of the number of actual, physical objects that may be printed based on a LEO file. Generally, any operation related to a LEO file as described herein may be performed for, or in relation to, a LEO file included in, or associated with a GREG file. An example of enabling a manufacturing device or enabling a unit to perform one or more manufacturing step may be providing a decryption key to thus enable the device or unit to use a 3D representation (that may be encrypted as described). Other examples of enabling and/or preventing devices and units to/from using information in a GREG file 810 are described herein.

The term “manufacturing step” as used herein may relate to any operation related to a digital asset. For example, a manufacturing step may be, or may include, processing digital information related to an object or design, e.g., processing a digital representation of an item. A manufacturing step may be, or may include, a step performed by a manufacturing system, e.g., a printing of an item may be a manufacturing step. As described, a manufacturing step may be performed based on information in a GREG or LEO file. It will be understood that the term manufacturing step is used herein for the sake of clarity and simplicity.

A manufacturing step may be, or may include, any usage of data associated with a GREG file by a manufacturing device, e.g., any usage of information in a GREG or LEO file, by a controller of a printer is considered a manufacturing step herein. Additionally, a manufacturing step may be, or may include, more than the usage or operations performed by a manufacturing system such as a printer. For example, preprocessing (pre-processing) steps such as rotating a set of 3D items or objects (e.g. rotating a digital representation of a set of 3D objects), nesting or placing several items in a bed or printing platform, slicing a bed, topological optimization, strength tests, strength simulation, printability check, generating and providing instructions to a robotic arm are considered manufacturing steps herein. Generally, and as known in the art, slicing may include translating a 3D model into individual layers from which machine code (used by a 3D printer) is generated.

Similarly, post-processing operations such as painting or dyeing an item, smoothing or milling an item (or other surface treatment), heating or cooling an item and so on are considered manufacturing steps herein. A manufacturing step may include the actual printing of a 3D item, e.g. deposition of polymer or metal substances according to a 3D design. Manufacturing steps can be performed on individual items or on batches of items.

Generally, any usage of data associated with a GREG or LEO file may be considered a production or manufacturing step. It will be noted that the term manufacturing step as used herein may relate to manufacturing or producing any object, including a digital object. A manufacturing step as referred to herein may be performed by a system that does not actually physically manufacture an item. For example, an operation performed in order to produce a 3D image for an advertising campaign is considered a manufacturing step since it uses data associated with a GREG or LEO file to produce the image, a process of identifying or listing parts of an item in a GREG file, e.g., for the purpose of generating a parts list or a cost estimate is considered a manufacturing step (that produces the list or cost estimate) and so on.

Reference is made to FIG. 8A, a block diagram of a GREG file 810 according to embodiments of the present invention. As shown, GREG file 810 may be associated with, or may include, GREG-level data 860, unprotected information 865, one or more LEO files 820, one or more GREG files 830, one or more tokens 840 (collectively referred to hereinafter as LEO files 820, GREG files 830 and/or tokens 840 or individually as LEO file 820, GREG file 830 and/or token 840, merely for simplicity purposes). A GREG or LEO file as referred to herein, e.g., GREG file 810 and/or LEO file 820, may be, or may include, any suitable digital data structure or construct, or computer data object. For example, GREG file 810 and/or LEO files 820 may be files or other suitable digital objects.

GREG-level data 860, unprotected information 865, LEO files 820, GREG files 830 and tokens may be, or may include, any suitable digital data structure or construct, or computer data objects, that enable storing, retrieving and modifying data and values. For example, GREG-level data 860, LEO files 820, GREG files 830 and tokens may be files, objects, tables or lists in a database in storage system 730, and may include a number of fields that can be set or cleared, a plurality of parameters for which values can be set, a plurality of entries that may be modified and so on. For example, information in a GREG file may be set, cleared or modified.

Content (e.g. data related to or describing objects to be printed) may be loaded from storage system 730 into memory 720 where it may be processed by controller 705. For example, GREG file 810 (or information therein) may be loaded into memory 720 and used for associating GREG file with a token, a GREG file or a LEO file as further described herein.

In some embodiments, only some of the objects associated with or described by LEO files 820 are included in GREG file 810. For example, using tokens 840, GREG file 810 may be associated with LEO files 820 thus the actual content or data of LEO files 820 may not be included in GREG file 810, for example, a GREG file 810 may include only tokens 840 and the data of LEO files 820, GREG files 830, unprotected data 865 and GREG-level data 860 may be obtained or retrieved, when needed, using tokens in tokens 840. For example, a token 840 of a LEO file is used for retrieving the actual content of the LEO file 820 from a database in storage system 730. In other embodiments, some or even all of the content of LEO files 820 and/or GREG files 830 may be included in GREG file 810. Of course, a combination may be used, e.g., a GREG file may actually include tokens 840 and unprotected data 856 and tokens may be used for obtaining actual data of LEO files 830.

GREG-level data 860 may include data relevant to a set of LEO files 820, GREG files 830 and tokens 840. For example, GREG-level data 860 may include combined or aggregated manufacturing rules for items in (or associated with) some of LEO files 820 and GREG files 830, e.g., for nesting, or GREG-level data 860 may include geometry data for a set of items etc. GREG-level 860 data may be created offline, e.g., before a GREG file 810 is sent to a client or GREG-level data may be calculated or created in real-time, on site, e.g., by control unit 870 connected to or included in a printer as described with reference to FIG. 8B.

As described, tokens 840 may be unique, e.g., there exist no two identical tokens 840 in a system. Any technique may be used to ensure tokens 840 are unique, e.g., tokens 840 may be created based on content in related LEO or GREG files. Any type of token described herein may be included in tokens 840 of GREG 810. For example, a first token included in tokens 840 of GREG file 810 may be a LEO token, e.g., a token of, or associated with a LEO that is included in (or associated with) GREG file 810, a second token included in tokens 840 may be a GREG token of a GREG file associated with GREG file 810 and a third token in tokens 840 may be a token of, or associated with, GREG file 810 itself.

Reference is made to FIG. 8B, a system according to embodiments of the present invention. As shown, GREG file 810 may be provided to a manufacturing system 890 that may be, or may include a printer or other device or system. For example, and as shown, a control unit 870 that may be, or include components of computing device 700 (e.g., a controller 705 and memory 720) may be provided (e.g., over a network or otherwise) with a GREG file 810. Control unit 870 may control print head 872 that may print items 875, 876 and 877 on print bed or platform 874.

Design representations of 875, 876 and 877, rules, constraints and any other information may be included, or associated with, GREG file 810. For example, based on data in GREG file 810, one of production materials 880 and 881 used to build items may be selected for manufacturing items 875, 876 and 877 in a single bed 874 or in a single run of manufacturing system 890. For example, production material A 880 may be powder that is to be sintered into nylon or titanium, production material B 881 may be powder that is to be sintered into titanium and so on. For example, based on design characteristics or other rules or constraints related to items 875, 876 and 877, an embodiment may automatically determine that production material A 880 can be used for manufacturing items 875, 876 and 877 together or substantially simultaneously, in a single batch or run, thus enabling manufacturing items 875, 876 and 877 at the same time or concurrently in a single platform or bed. Of course, any other manufacturing steps (e.g., preprocessing steps and post-processing as described herein) may be selected, and performed by manufacturing system 890, based on data in input GREG file 810. For example, the same color for painting items 875, 876 and 877 may be selected based on data in GREG file 810 and so on.

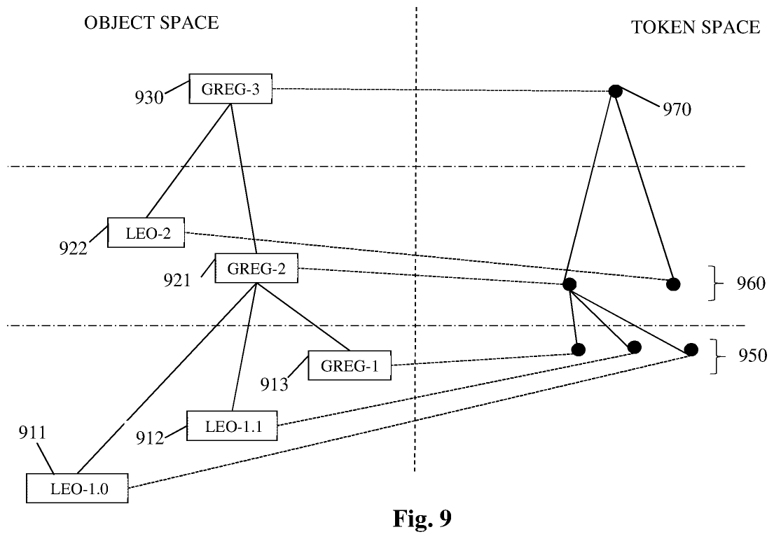

Reference is made to FIG. 9 which shows objects and associations according to embodiments of the present invention. FIG. 9 graphically illustrates association and hierarchy of GREG files, LEO files and tokens. As shown, in object space, a first level may include two LEO files (LEO-1.0 911 and LEO-1.1 912) and a GREG file (GREG-1 913). As illustrated by the dashed lined connecting LEO-1.0 911, LEO-1.1 912 GREG-1 913 with tokens 950 in token space, each of the files in the first level may be associated with a unique token included in tokens 950.

As further shown, the files in the first level are associated with a GREG file in the second level (GREG-2 921), this association is illustrated, in the token space of FIG. 9, by the solid lines connecting tokens 950 with the token of GREG-2 921 in tokens 960. As further illustrated in both object and token spaces, LEO-2 922 and GREG-2 921 may be associated with GREG-3 930 in a third level, this association is shown, in token space, by the lines connecting tokens 960 with token 970. For example, GREG file 810 in FIG. 8A may be GREG-3 930, LEO files 820 may be any one or more of LEO-1.0 911, LEO-1.1 912 and LEO-2 922 and GREG files 830 may be GREG-2 921 and GREG-1 913.

Some embodiments may determine, based on the at least one GREG token 840, a respective set of design characteristics of a respective set of items; and determine whether or not a manufacturing step can be performed for the entire set of items. For example, based on one or more of GREG tokens 840, web services 230 or control unit 870 may determine whether or not a set of items associated with one or more of GREG tokens 840 can be printed or manufactured, or painted or otherwise processed at the same time, in the same batch or on the same printer bed.

Design characteristics of an item may include, for example, a material used for manufacturing the item (e.g., Nylon, Polyamid, Titanium, Aluminum, Bronze etc.). For example, to manufacture or print a first item described or included in, or associated with, one of LEO files 820 in GREG file 810 a first temperature range (e.g., 55° C.-65° C.) may be required (e.g., the temperature of production material 880 when extruded by print head 872 or bed temperature around (in or of) print bed 874, and to manufacture or print a second item described or included in, or associated with, another one of LEO files 820 in GREG file 810 a second temperature range may be required. Staying within the temperature example, to determine whether or not a manufacturing step (e.g., printing) can be performed for the two items together (e.g., in same print bed or printing platform or print run), an embodiment (e.g., web services 230 or control unit 870) may check, compare or relate the first and second temperature ranges and, if the ranges at least overlap, web services 230 or control unit 870 may determine the printing manufacturing step can be performed for the two items together, as a group. If the two ranges do not overlap, then web services 230 or control unit 870 may determine the two items cannot be printed together (a manufacturing step cannot be performed for the two items together).

For example, if a first item requires a temperature range of 60° C.-85° C. and a second item requires a temperature range of 50° C.-80° C. then an embodiment may determine a processing step of printing the two items together can be performed (e.g., using a temperature range of 60° C.-80° C. which is suitable for both items), however, if the second item requires a temperature range of 55° C.-59° C. then an embodiment may determine a processing step of printing the two items together cannot be performed.

Although design characteristics related to temperature are mainly discussed, other design characteristics may be relevant. For example, design characteristics related to the number of items allowed to be manufactured or a geometry, a color, a resolution, a scale, a texture, a material, a size, a setting required on the printer (other than temperature), and a value extracted from a computer-aided design (CAD) object may be used as described with reference to the temperature example above. For example, if (based on its design characteristics in its LEO file) a first item requires (or permits) a range of layer heights, e.g., layer height of 0.1 millimeters (mm) or 0.2 mm or 0.3 mm and a second item requires layer heights of 0.2 mm or 0.3 mm or 0.4 mm then web services 230 or control unit 870 may determine that the (pre-processing) manufacturing step of slicing can be performed for the first and second items together, using layer height of 0.2 mm or 0.3 mm (which, in this example are the overlapping or common layer heights that are permitted for the first and second item) but if the second item requires layer height 0.4 mm then web services 230 or control unit 870 may determine the slicing manufacturing step cannot be performed for the first and second items together.

If it is determined, based on data in, or associated with, a GREG file, e.g., based on examining rules or constraints of a set of design characteristics of a GREG files as described, that a manufacturing step cannot be performed then server 120 or web services 230 may perform one or more actions. For example, data may be added to, or associated with or modified in the GREG file, e.g., counters may be incremented or decremented, rules may be updated and so on, other actions may be generating such as sending a warning to a user, displaying an alert on a computer screen and so on.

If it is determined, based on design characteristics as described, that a manufacturing step can be performed for a set of items as described, information may be added to GREG-level data 860. For example, in the above temperature example, web services 230 or control unit 870 or another unit may store, in GREG-level data 860, the temperature range of 60°-80° which can be used for both items. Accordingly, an embodiment may identify, create, record and provide an aggregated set of design characteristics and data associated with the design characteristics as described for a plurality of items, the set of design characteristics usable for performing one or more manufacturing steps for the plurality of items, together, as a group. For example, an aggregated (or identified) set of design characteristics of a respective set of items (e.g., the subset of overlapping constraints of a number of item designs) may enable, or be used for, selecting one or more manufacturing steps for a set of (possibly different) items. For example, based on the design characteristics of a set of items in (or associated with) a GREG file, an embodiment may determine that the set of items can be printed in a single printer bed, or printing platform. Other manufacturing steps that can be used for a set of items may be identified, selected or enabled as described, e.g., pre-processing and post-processing steps as described herein. It will be understood that the temperature and slicing related manufacturing steps are only some examples and an embodiment may determine whether or not any other manufacturing steps, e.g., preprocessing, actual printing and/or post-processing may be performed for a set of items as a whole or together as a group. Identifying a set of design characteristics that is suitable for, or usable by, a single or same manufacturing step is an advantage and improvement of the field. For example, GREG file 810 may include, or be associated with, hundreds of different items' designs that may each be associated with a large number of different (sometimes conflicting) constraints or design characteristics, identifying a set of constraints or design characteristics that is suitable or usable for some or even all of the items enables performing one or more manufacturing steps for an entire set of items, something current or known systems and methods cannot do.

Determining whether or not a manufacturing step (e.g., slicing, printing, painting) may be performed as described may enable embodiments of the invention to enforce the will of an owner of design or digital asset. For example, using embodiments of the invention, an owner of a design can control usage of his design, e.g., even though the owner may not be the one who is using the digital asset. For example, in the above layer heights example, the layer heights of 0.1 mm, 0.2 mm or 0.3 mm or 0.4 mm may be defined by the owners of the designs who want specific attributes for their product. Thus, in the example above, an embodiment takes into account the interests of the owners and/or enforces their will. By identifying a set of constraints or design characteristics that are in accordance with the design owner's requirements for each and every item in the group, embodiments may enable only manufacturing steps that are allowed by the owners. Of course, whether or not a manufacturing step may or can be performed may be determined based on other data, e.g., an embodiment may determine whether or not a step may or can be performed based on design characteristics and further based on capabilities, characteristics or setting of a manufacturing device as described. Other improvements over prior art systems may occur.

Embodiments of the invention may improve the field of 3D printing by enabling an automated selection of a set of items and a respective set of settings or constraints (e.g., color, production material etc.) such that the set of items can be manufactured in a single run or batch using a 3D printer as described. Embodiments of the invention may improve the field of 3D printing by aggregating a set of designs (e.g., included in or associated with a set of LEO files as described) into a single file (e.g., a GREG file as described) thus enabling providing a set of designs together, e.g., in a single file, to a manufacturer or distributor of designs. Embodiments of the invention may improve the field of 3D printing by disaggregating a set of designs in a single file (e.g., in a GREG file as described) into two or more files, e.g., into one or more GREG files and/or LEO files, thus, for example, enabling a distributor to send a first amount or type of designs to a first manufacturer (e.g., subcontractor) and send a second amount or type of designs to a second manufacturer.

In one embodiment a unit such as web services 230 or control unit 870 may receive a definition or description of a manufacturing step and may identify a group of items that can be processed together by the manufacturing step. Accordingly, given a specific, or description of a manufacturing step, an embodiment may find (and inform a user of) a set of items or digital assets associated with a GREG file that can be processed together in, or by, the manufacturing step. For example, if a definition or description of a manufacturing or processing step indicates that the color of material used in the step is green then web services 230 or control unit 870 may identify (e.g., based on design characteristics in LEO files 820) all items associated with GREG file 810 that must or may be colored green. In some embodiments a definition or description of a manufacturing step can be, or be based on, device characteristics as described. For example, a printer may be able to use only green color and accordingly, a definition of a coloring step may include green. In another example, assuming red raw material is very cheap and green raw material is very expensive, a user may want to find out how many, or which, red items associated with a GREG file can be made, in such case, the user may query web services 230 or control unit 870 using an input GREG file and a red raw material for a manufacturing step description and be provided with the number and/or type of items and/or be provided with an output GREG file that is associated with the type and number of items, associated with the input GREG file, that can be manufactured in red.

In another example, a definition or description of processing step may include a (possibly maximal) resolution of (or supported by) a printer, accordingly, an embodiment may identify all items in GREG file 810 that can be printed using the resolution supported by the printer. Accordingly, an embodiment can match or associate items with specific manufacturing steps. It will be noted that receiving a definition or description of a manufacturing step and identifying a relevant group or set of items as described can be performed at any time.

For example, if a user wants to find out whether or not his or her device can perform a manufacturing step for all or some of the items in GREG file 810 then the user may provide a description of the manufacturing step (e.g., to web services 230 or control unit 870) and be provided, by web services 230 or by control unit 870, with an indication of how many and/or which of the items can be processed in the manufacturing step. For example, a definition or description of a manufacturing step may include information related to a size, temperature, a color, a resolution, a scale, a texture or a material or a value extracted from a computer-aided design (CAD) object.

In one embodiment a unit, e.g., web services 230 or control unit 870, may modify a first GREG file based on information associated with at least one of a LEO file and a second GREG file. For example, a first GREG and/or LEO file, or information in these files, may be included in, or associated with, a second GREG file. For example, referring to FIG. 9, at a first point in time, existing GREG-2 921 may include, or be associated with, only LEO-1.0 911, next or subsequently, GREG-2 921 may be updated or modified (e.g., by web services 230 or control unit 870) such that it includes, or is associated with, LEO-1.1 912 and GREG-1 913. For example, LEO files 820 of GREG-2 921 may be updated to include some or even all of the information in LEO-1.1 912 or tokens 840 in GREG-2 921 may be updated to include the tokens of LEO-1.1 912 and GREG-1 913 or new tokens associated with LEO-1 and/or GREG-1 (shown by tokens 950). Accordingly, an embodiment may aggregate digital assets such as design representations and characteristics in a plurality of files (e.g., LEO and/or GREG files or unprotected information therein) into a single file, e.g., into an existing GREG file as described.

For example, a new or additional GREG file produced based on input (or source) LEO files and/or based on input (or source) GREG files may include, or be associated with, a token that is usable for controlling or managing a manufacturing device, e.g., enabling or preventing a manufacturing device to/from manufacturing at least one of the items described in the input or source LEO and GREG files. Any other manufacturing steps as described herein may be controlled or managed by the new GREG file. The new or additional GREG file produced may include, or be associated with, one or more tokens that are usable for controlling or managing any relevant entity, e.g., enabling or preventing a 3^{rd} party or other software unit to/from performing a manufacturing step related to items described in the input or source LEO and GREG files.

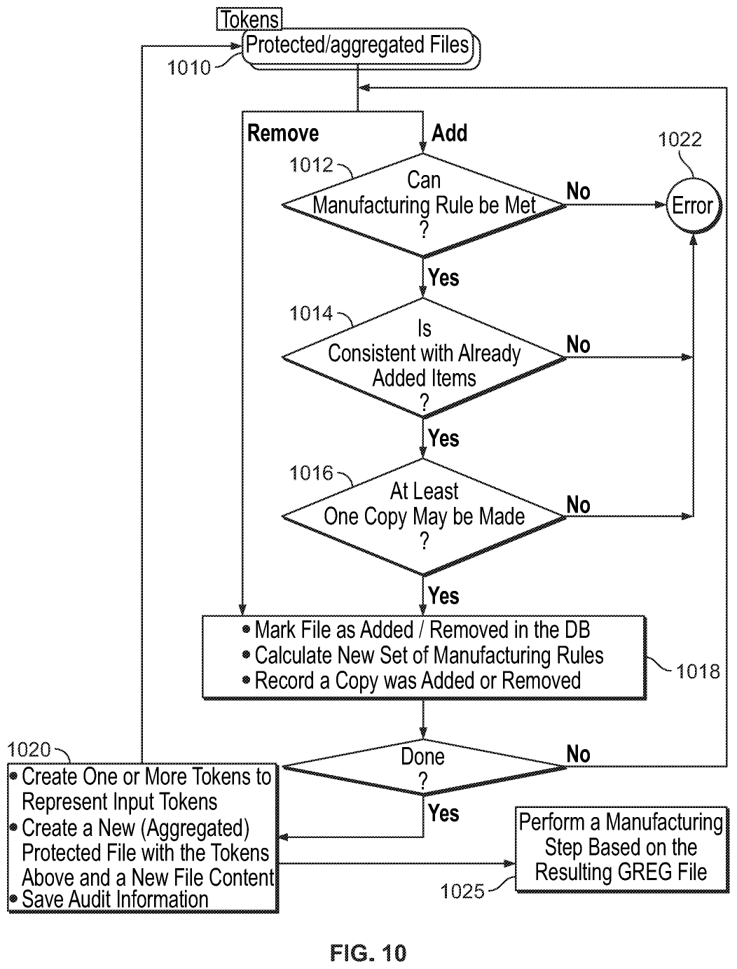

Reference is made to FIG. 10 which shows flowchart diagram of a method according to embodiments of the present invention. Generally, input to the flow shown in FIG. 10 may be one or more digital assets, e.g., data related to items included in LEO or GREG files as described, each with its own characteristics, rules and constraints. An output of the flow shown in FIG. 10 may be one or more digital assets and a combined or merged set of rules as dictated by the input (e.g., rules associated with input assets). New rules may be calculated or provided as input to the flow and added to the output, e.g., rules related to nesting may be created such that they are applicable to the set of input assets, e.g., a geometry that includes all the geometries of the input digital assets. For example, the flow may describe combining or aggregating information in GREG-2 921 and in LEO-2 922 to create GREG-3 930 or the flow may describe updating GREG-2 921 to include LEO-1.0 911.

Generally, input provided to the flow shown in FIG. 10 may be GREG or LEO files and an output or result of the flow may be one or more GREG files (referred to herein as output or resulting GREG for simplicity). It will be understood that an output or resulting GREG file as referred to herein may be dynamically modified during the flow, e.g., following a first iteration of the flow, an output or resulting GREG may include, or be associated with, a first item (e.g., a doll) and, following a second or subsequent iteration, the output or resulting GREG may include, or be associated with, the doll and a toy horse.

The flow shown in FIG. 10 may be relevant to updating an existing GREG file, e.g., the resulting GREG file is an updated or modified GREG file that existed before the flow was performed or, the flow may include creating a new GREG file, e.g., existing one or more GREG files and/or LEO files are aggregated, merged or combined to create a new GREG file.

As shown by block 1010, a plurality of protected and/or aggregated files or objects may be provided as input. For example, input 1010 may be, or may include, one or more GREG files 810 and one or more LEO files and one or more unprotected files as described herein, as further shown, each of the input objects may be associated with one or more tokens.

As shown by block 1012, an embodiment, e.g., web services 230 may check whether or not a manufacturing rule can be met. For example, one or more manufacturing rules of an already existing GREG file may be evaluated with respect to rules in an input GREG or LEO file included in input as shown by 1010. For example, if an existing GREG file into which an input GREG file is to be inserted, or aggregated, already includes (or is associated with) a manufacturing rule that cannot be applied to the input GREG file in 1010 then the flow may produce an error as shown by block 1022 and the flow may further include indicating to a user or to an application that the input GREG or LEO file cannot be added to the existing GREG file. For example, if a manufacturing rule includes one color (e.g., green) for all items, and a rule or design characteristics of an input object in 1010 requires the item to be red then the manufacturing rule cannot be met and the item cannot be added. Similarly, other rules or constraints may be relevant, e.g., a resolution may be checked as described with reference to color in the above example.

As shown by block 1014, the flow may include checking whether or not an input object is consistent with items already included in, or added to, an existing GREG file. For example, a rule in an input GREG file that requires or dictates that items manufactured will be produced in polyamide material may be consistent with items in an existing GREG file if the items in the existing GREG file can be manufactured using polyamide, but a rule in an input GREG file that requires titanium material may be inconsistent for that existing GREG file.

For example, a nesting software may, e.g., by default, attempt to place objects 1 centimeter a part but a design rule for nesting specifies that at least one of the objects associated with a GREG file may require that the object be placed no less than 2 centimeters from any other object, in such case, the rule for the object may be considered, determined or identified, as inconsistent with a definition of a manufacturing step and/or inconsistent with rules for other objects or items associated with the GREG file. Such inconsistency may be identified and dealt with, by an embodiment as described.

As shown by block 1016, the flow may include checking whether or not at least one copy (of an item in the input GREG file) can be made or may be manufactured. For example, based on production tokens or a counter of already manufactured copies, web services 230 or control unit 870 may determine whether or not additional copies of the item may be manufactured, as shown, if no more copies are permitted to be made then the flow may generate an error (1022) as described, e.g., an error message may be displayed on a computer screen informing that an input object in 1010 cannot be added to a GREG file because the number of permitted copies has been exhausted.

As shown by block 1018, an embodiment may mark a file (e.g., a GREG file) as added or removed, in a database, e.g., in database 234 in the DB, calculate or obtain a new or additional set of manufacturing rules and add the set to the GREG-level data 860 of the existing GREG file, and record, e.g., in a database, that a copy was added or removed (e.g., decrease a counter or delete or remove a token as described).

As shown by block 1020, an embodiment may create one or more tokens which represents some (or even all) of the input tokens, create a new (aggregated) protected file associated with the created token and create new file content and associated information, e.g., update an existing GREG and its associated information with newly created content to reflect the addition or association of an item and save audit information. A GREG file produced as shown by the flow in FIG. 10 may be provided, e.g., to a 3D printer. As shown by block 1025, an embodiment may perform one or more manufacturing steps based on the GREG file produced by the flow, e.g., an embodiment may print an item associated with a GREG file produced as shown by the flow in FIG. 10. As shown by the arrow connecting block 1020 back to the top block 1010, modification of a GREG file may be an iterative process in which the output is used as input, e.g., after information in a LEO or GREG file has been added to a GREG file as described, the flow shown in FIG. 10 may be repeated, e.g., to include information in additional LEO or GREG files to the GREG file. In some embodiments, if an input object in 1010 can be manufactured under the manufacturing rules of an output GREG file and the input object is consistent with other items in the output GREG file and at least one copy of an item associated with the input object can be manufactured then a token (e.g., a GREG token as described) may be updated such that the token is associated with the input object. In the case that a new GREG file is created by the flow, a new token may be created as well as a new file (GREG file). As further indicated, audit information may be generated and provided, e.g., stored in a database. For example, audit information may include a listing of all items associated with the resulting GREG file, rules, quantities and the like. For example, any data that may be included in GREG-level data 860 may be created and stored, e.g., in GREG-level data 860 of the resulting GREG file and/or in a database, in association with at least one token associated with the resulting GREG file. For example, a set of manufacturing rules or constraints (e.g., settings, configuration or other data related to nesting of items and geometry) calculated for all the items associated with the resulting GREG file may be created and stored in GREG-level data 860 of the resulting GREG file. Generally, and as known in the art, nesting, or 3D nesting or packing is the process of sorting, orienting and/or otherwise arranging 3D items in a 3D space such that they fit in a bed or platform of a 3D printer when manufactured. Audit information saved as shown by block 1020 may generally include information that describes who did what (and/or when and where) with a GREG file. For example, audit information may include details identifying the software that processed data in a GREG file, the actual items manufactured, the user of firm who used data in a GREG file, a time and place when and where a digital asset was accessed and/or used and the like.

It will be noted that an iteration of adding or aggregating items may add a single item to the resulting GREG file or the iteration can add two or more items, e.g., when in batch mode that adds a set or batch of items together, as a group, to a GREG file. For example, the operations described in blocks 1012, 1014, 1016, 1018 and 1020 can be performed for a single item, a plurality of same or identical items and/or a plurality of different items. For example, an iteration may add or associate a single doll to a GREG file, add a plurality of dolls to the GREG file or add one or more dolls and one or more toy horses to the GREG file.

In some embodiments a new (second) GREG file, may be created based on an existing (first) GREG file, and/or based on a LEO file. For example, referring to FIG. 9, at a first point in time, GREG-3 930 may not yet exist, then web services 230 or control unit 870 may use information included in, or associated with, a LEO-2 922 and information included in, or associated with, GREG-2 921 to create (new) GREG-3 930. An embodiment may use a token associated with the new, second GREG file to enable a manufacturing device to perform a manufacturing step for at least one of the items described in the LEO file and/or the GREG file used for creating the new GREG file.

An embodiment may use a token associated with the new, second GREG file to enable a unit (e.g., a 3^{rd} party or other software unit or program) to perform a manufacturing step for at least one of the items described in, or included or associated with, the LEO file and/or GREG file which are used for creating the new GREG file. For example, web services 230 may update or create token 970 of the new GREG-3 930 such that it is usable for performing one or more manufacturing steps for items included, described or associated with GREG-2 921 and/or LEO-2 922 which, in the above example, are used for creating the new GREG-3 930 file.

For example, to create GREG-3 930 (the second or new GREG file), web services 230 may create token 970 and associate token 970 with tokens 960 thus associating LEO-2 922 (a LEO file) and GREG-2 921 (the first, original or existing GREG file) with GREG-3 930. In some embodiments, to associate LEO-2 922 and GREG-2 921 with GREG-3 930, tokens 960 may be included in tokens 840 of GREG-3 930. Of course, instead of, or in addition to, associating GREG-3 930 with LEO-2 922 and GREG-2 921 using tokens as described, web services 230 may include actual data or information from (included in) LEO-2 922 and/or GREG-2 921 in GREG-3 930. For example, LEO file 820 in GREG-3 930 may be, or may include data obtained from LEO-2 922 or it may simply include LEO-2 922, similarly, a GREG file 830 in GREG-3 930 may include some or even all of GREG-2 921. Accordingly, an embodiment may aggregate LEO and/or GREG files into a GREG file such that the resulting GREG file is usable for performing manufacturing steps for items represented in the LEO and/or GREG files.

Accordingly, aggregating digital assets may include updating or modifying an existing GREG file based on other GREG or LEO files and/or aggregating digital assets may include creating a new GREG file based on one or more GREG and/or LEO files. It will be understood that a GREG file may be created based on just one LEO file as described (e.g., by associating a token of the LEO file in the GREG file), based on a plurality or set of LEO files, based on a single GREG file and/or based on a plurality of GREG files. For example, in some embodiments, a token associated with a GREG or LEO file may be used to obtain or retrieve, e.g., from a database (e.g., from database 731), any or all of the data of, or included, or associated with the GREG or LEO file, accordingly, updating or creating a GREG file by including/associating tokens of another (source or original) GREG or of a LEO file in/with another GREG file (e.g., tokens of GREG-2 921 and/or LEO-2 922 are used to create or update GREG-3 930) enables using the updated or created GREG file for performing any manufacturing step or operation related to items in the original or source GREG or LEO files since, using the tokens of the original or source GREG or LEO files (now associated with the updated or new GREG file) any information of the original or source GREG or LEO files can be obtained and used.

An embodiment, e.g., web services 230 or control unit 870, may create, based on a first GREG file and/or based on a LEO file, a second GREG file, such that the second GREG file is associated with (or includes) at least some information related to at least one item associated with the first GREG file or the LEO file.

In embodiments, a GREG file may be fully or partly duplicated, for example, a GREG file associated with a set of 100 dolls may be (fully) duplicated such that a new substantially identical GREG file associated with a set of same 100 dolls is created, or, a GREG file associated with a set of 100 dolls may be (partially) duplicated such that a new, additional GREG file associated with a set of 20 dolls is created.

In some embodiments, a GREG file may be split, converted or transformed (disaggregated) into two or more GREG files and/or two or more LEO files and/or one or more GREG files and one or more LEO files such that digital assets associated with, or managed by, the GREG file are distributed over the two or more GREG files and/or two or more LEO files. Splitting, converting or transforming a GREG file may be, or may include, disaggregation of digital assets. For example, an input or original GREG file associated with a set of 100 dolls and 100 toy horses may be split, converted or transformed into two (output or resulting) GREG files, one associated with 50 dolls and 20 toy horses and another one associated with 50 dolls and 80 toy horses. Of course, the total number of a specific item may be changed when a GREG file is split, converted or transformed, e.g., it may be increased or decreased. For example, a split, modification or transformation of an input GREG file associated with 100 dolls and 100 toy horses may produce a first GREG file associated with 80 dolls and 10 toy horses and a second GREG file associated with 80 dolls and 10 toy horses, thus the number of (permitted copies or instances for) a first item or digital asset may be increased and the number for a second item may be decreased when a GREG file is split, converted or transformed into two or more GREG or LEO files. For example, a split, modification or transformation process, operation or flow may receive, as input, GREG-3 930 and produce, as output, LEO-2 922 and GREG-2 921.

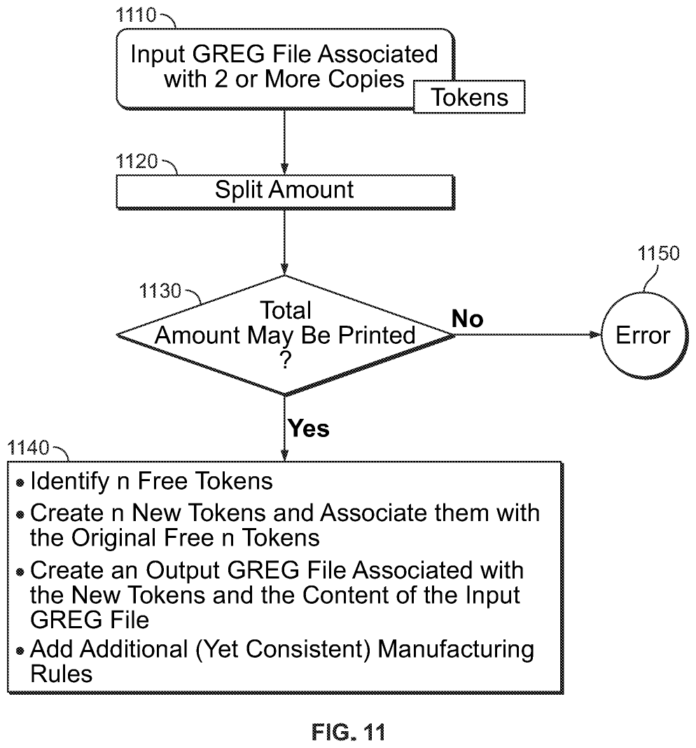

Reference is made to FIG. 11 which shows flowchart diagram of a method according to embodiments of the present invention. As shown by block 1110, an input GREG file associated with one or more tokens and with an amount of physical items that may be manufactured may be provided as input. It will be noted that input to the flow may be a token of a GREG file, as described, the token may be used to obtain, from a database, some (or even all of) the information and data in, or associated with, an input GREG file. As shown by block 1120, the number of items may be split, e.g., the number of dolls that may be produced using the input GREG file may be split or divided into 30, 30 and 40. As shown by block 1130, an embodiment may verify that the total amount of physical items that may be printed, after the split, may be printed, e.g., if the total number of copies permitted to be made or manufactured is increased in the split, web services 230 may verify that the total number does not exceed a permitted or threshold number (e.g., a total number of physical items the owner of a design indicated). For example, the number of copies for an item may be represented by tokens (e.g., to represent and enforce a total number of 100 items that may be manufactured, 100 manufacturing tokens are used). Accordingly, an embodiment may check, as shown by block 1130, whether or not the split can be performed by checking availability of tokens. As shown by block 1150, if there are no available or usable tokens, the flow may terminate and provide an alert, e.g., inform a user the split cannot be carried out.

If tokens are available, a split may be performed by creating new files, such as a new GREG or LEO file that is associated with some of the items associated with the input GREG or LEO file. For example, in some embodiments, the number of copies that may be manufactured is represented by tokens, each time an item is manufactured, a token is modified, removed or deleted, thus the number of tokens left (available) indicates the number of items that can still be manufactured, accordingly, checking if tokens are available or exist, for an item, then the item may be manufactured, made or printed, if no tokens are available then it may be that no more items can be manufactured or printed. As described, in some embodiments, a counter may be used, e.g., the counter may be decreased to reflect the number of items manufactured, accordingly, the number of copies that may be manufactured may be represented by the value of the counter and, accordingly, instead of checking if tokens are available an embodiment (e.g., web services 230) may check whether or not the counter's value is zero (“0”).

As shown by block 1140, free tokens may be identified, e.g., in database 234 where the amount of physical items permitted to be made is represented by a respective number of tokens, new tokens may be created and associated with the tokens found in the database, an output (new or additional) GREG file may be created based on content of the input GREG file and the output GREG file may be associated with the new tokens and rules or other data may be added to, or included in, the output GREG file, e.g., information in GREG-level data 860 may be updated such that items in the output GREG file can be processed as described, e.g., together, in one or more processing steps as described.

Some embodiments may select first and second amounts such that their sum equals an amount of item copies that may be manufactured, e.g., permitted to be manufactured based on available tokens as described or based on a value associated with a GREG file (referred to herein as input, original or existing GREG file). The amount selected may be equal to, or less than, the amount of allowed copies associated with an input GREG or LEO file. A first and second amounts may be selected such that their sum equals, or is less than, the amount of copies of an item that are permitted to be manufactured according to the input GREG file.

The input GREG file may be modified such that it is usable for manufacturing the first amount of copies of the items and a new, additional, GREG file may be created and associated with the second amount such that the new or additional GREG file is usable for manufacturing the second amount of copies of the item.

For example, a distributor may receive a GREG file usable for printing 100 dolls and, e.g., using web services 230 or a similar unit operated by the distributor, the distributor can split the GREG file into first and second GREG files usable for manufacturing 30 dolls and 70 dolls respectively, provide the first GREG file to a first subcontractor or manufacturer and provide the second GREG file to a second manufacturer.

As described, according to some embodiments of the invention, aggregation or disaggregation of digital assets may be performed by updating, modifying, splitting, transforming and/or combining GREG and/or LEO files. For example, and as described, the total number of items that may be printed may be increased or decreased by updating, modifying, transforming, splitting and/or combining GREG and/or LEO files, types of items may be distributed and redistributed between GREG and/or LEO files and so on.

Information related to a LEO file and/or a GREG file that is associated with an input GREG file may be removed from the input GREG file. For example, by deleting one of LEO files 820 and/or deleting or removing one or more tokens 840 in GREG-3 930, LEO-2 922 and/or GREG-2 921 may be removed or disassociated from GREG-3 930. For example, if LEO-2 922 is associated with (a printable design of) dolls and thus, GREG-3 930 may be usable for managing or controlling production steps related to the dolls as described, the dolls may be removed from GREG-3 930 by removing or disassociating LEO-2 922 from GREG-3 930 and/or by removing the relevant tokens from GREG-3 930 as described.

Information related to usage (usage information) of data associated with a GREG file may be recorded and the recorded information may be included in, or associated with, the GREG file. Usage information as referred to herein may be information related to, or describing, any manufacturing step as described herein. For example, usage information may include details related to, or even an indication of, a nesting, slicing, topological optimization, strength tests, or printability check operation performed as described for items associated with a GREG file and, of course, any information related to an actual production of an item (e.g., how many copies were made, when, where and by who) may be usage information may be recorded as described.

For example, usage information may be associated with a token of the GREG file. Usage information may be used, for example, to inform a designer (design owner) of usage or status of his or her design or the information may be used for billing etc. For example, based on usage information recorded as described, an embodiment may report to an owner of a design how many copies of the design were actually made and by who. In another example, an embodiment may report to a user that a digital 3D image was produced based on a design in a GREG file (e.g., by a 3^{rd} party software unit), that a parts list was created and so on.

Information of, included in or associated with, a first GREG file token may be used for retrieving, e.g., from a database or storage system, a LEO token and/or a GREG token. For example, using an association as illustrated in the token space in FIG. 9, a token of LEO-2 922 in tokens 960 may be located, obtained or retrieved (e.g., by web services 230) using token 970. For example, pointers, common table entries or rows or linked lists may be used to associate or link tokens such that give a first token, a second token can be obtained. As described, generally, using a token, any information included in the GREG or LEO file associated with the token may be obtained, accordingly, association of tokens as described herein enables or implies a similar association of GREG or LEO files. For example, using token 970, web services 230 or control unit 870 can obtain all of tokens 960 and 950 thus gain access to all the GREG and LEO files in the hierarchy shown in FIG. 9.

A GREG token may be used, e.g., by web services 230 or control unit 870, for at least one of: selecting, enabling and controlling a manufacturing step that may be an actual manufacturing (e.g., printing) step, a pre-processing process or step and/or a post-manufacturing process or step. For example, a software unit may need to rotate a digital representation of a set of items in a GREG file and may use (e.g., include) the associated GREG token in a request to apply the rotation.

Generally, rotation as referred to herein may include transformation in which a (digital representation of) a 3D object is turned or rotated around one of the X/Y/Z axis. For example, one of the axes may be kept fixed, serving as the center of rotation, and the digital representation of the 3D object is rotated about the fixed axis, by a given angle or degree.

Using the GREG token, web services 230 or control unit 870 (or another unit adapted to process GREG and LEO data as described) may determine whether or not the rotation can be applied, e.g., whether or not the set of design characteristics or rules associated with the GREG file allow or permit the rotation. It is noted that, as described, permitting or preventing a step may be based on a rule set or other data that takes into account all the items or assets associated with the GREG file, e.g., a decision to allow a rotation may be reached by web services 230 or control unit 870 only if each of the items can be rotated and, in addition, if of all the items in the GREG file can be rotated, together, as a group.

Generally, enabling a manufacturing step may be, or may include, providing a decryption key that enables decrypting an encrypted digital design representation, preventing a manufacturing step (e.g., preventing a unit from rotating, slicing or nesting) may include denying a request for a decryption key, controlling or managing a manufacturing step may include limiting an amount of items printed, providing a set of parameters (e.g., color) and so on. Accordingly, embodiments of the invention may use a token to control or manage not only a manufacturing device such as a printer but also any unit (software or other) that wishes to use data in GREG or LEO files. Controlling or managing as described may also include generating an alert. For example, an attempt to place a set of items outside a space defined in a GREG file, e.g., as determined by web services 230 or control unit 870, may cause web services 230 or control unit 870 to issue a warning to a user.

A GREG token may be used for controlling the number of item copies manufactured. For example, a manufacturing device may use a GREG token in a way similar to using a LEO token as described, e.g., the GREG token may be included in a request to print 50 copies, the request may be granted for example by a decryption key as described and the total number of items permitted to be manufactured may be decreased by 50, e.g., in a counter associated with the GREG token, in a database or by decreasing the number of print tokens associated with the items.

Unprotected information (e.g., unprotected information 865) may be included in a GREG file. For example, unencrypted information, e.g., native language instructions for an item may be included in a GREG file such that printing of the item can be performed without token based control as described. For example, a GREG file may be used as a container for any (non-LEO or non-GREG) data including data usable by any unit or device. For example, unprotected information or data may be, or may include a set of native language instructions, or any CAD data. For example, including unprotected information may enable adding, to a GREG file, digital representations of items from any source and nesting of the items associated with the GREG file as described and the added items, together, e.g., in preparation for a print run. Accordingly, a GREG file may include protected (e.g., encrypted) and managed items as described and, the GREG file may further include unprotected items. For example, a subcontractor that receives and uses a GREG file as described may add, to the GREG file, items from any source such that a run of his or her printer prints items in the GREG file as described and, in addition, the same printer run prints other items that were not included in the GREG file as received. It will be noted that unprotected information 865 may include data of any type or format and, accordingly, the scope of the invention is not limited by the content of unprotected information 865.

In some embodiments, a specific number of physical items that can (or that are allowed to) be manufactured based on a design may be set and used such that no more than the specific number of items can be made. For example, a designer may want to limit the number of dolls s/he designed. For example, in one embodiment, a GREG or LEO file may contain a token for each copy of an item, e.g., if only 15 copies are allowed then GREG file 1110 may include 15 tokens relevant to that item. In some embodiments, each time an item is manufactured, a token is removed from the GREG or LEO file, or a token associated with the item is marked as deleted or used, e.g., in the GREG file and/or in database 731, and manufacturing an item may be prevented, blocked or disabled if no tokens relevant to an item are left in the GREG file.

In other embodiments or configurations, tokens and/or counters are stored in server 120 or web services 230 (and are pointed to using a pointer in a GREG or LEO file). For example, GREG and LEO files (e.g., GREG-3 930, LEO-2 922 and so on) in the object space shown in FIG. 9 may be stored in a system operated by a user or client and tokens in the token space shown in FIG. 9 (e.g., tokens 970, 960 and 950) may be stored in, and managed by, server 120 and/or web services 230, e.g., tokens and counters may be stored in database 731 that may be operatively connected to server 120.

In some embodiments, counters may be used as described. For example, a counter associated with a token may be stored in, and/or managed by, server 120 or web services 230, and may be decremented each time an item is made as described, and, for example, manufacturing an item may be prevented, blocked or disabled if a the value of a counter associated with the relevant token is zero. In some embodiments, when an item is made or manufactured, e.g. by a 3D printing device, a relevant token may be deleted, or marked as used or marked as deleted, e.g., in server 120 or web services 230, and manufacturing an item may be prevented, blocked or disabled if no relevant tokens are left in server 120 or in web services 230.

Associating a token or counter with a GREG or LEO file may be accomplished, for example, by including, in the GREG or LEO file, a reference or pointer to the token or counter. For example, a unique identifier or reference included in a GREG file may unambiguously or uniquely identify a token in a database and may thus be used to retrieve the token, e.g., from database 731 in server 120, thus the unique identifier or reference may associate or link to GREG file with the token. Any other methods, e.g., pointers, may be used to associate or link a token or counter to a GREG or LEO file, similar methods may be used to link or associate a first token to a second token, or link or associate tokens and counters. For example, token 970 may include pointers or references to tokens 960 and tokens 950 may include pointers or references to counters in database 731. It will be understood that when a GREG or LEO file including a token is described herein this may mean the GREG or LEO file may be associated with a token, that is, including a token may be including a reference to a token. Similarly, when a token of a GREG or LEO file is described it is meant the token is associated with the GREG or LEO file.

Associating a token or counter with a GREG or LEO file may be accomplished by simply including the token or counter in the GREG or LEO file. In some embodiments, associating a token or counter with a GREG or LEO file may be accomplished by including in the GREG or LEO file a pointer, reference or identifier that may be used to find and/or retrieve the token or counter as described. In some embodiments, a token and/or counter may be associated with a GREG or LEO file or with an item in the GREG or LEO file by including the token and/or counter in the GREG or LEO file and, in addition, including a reference in the GREG or LEO file to a stored a copy or instance of the token or counter in a remote database, e.g., in database 731. Accordingly, some operations involving tokens and/or counters as described herein may be performed, by embodiments of the invention, based on tokens and counters in a GREG or LEO file, other operations may be performed based on tokens and counters in a database that is remote from the relevant GREG or LEO files and yet other operations may be based on tokens and counters in a GREG or LEO file and, in addition, based on counters or tokens in a remote database.

An embodiment may create a LEO file 820 or create a GREG 810 file that includes a design of an item, (e.g., a design included in an STL file as described) and the embodiment may encrypt at least some of the content in the GREG or LEO file, e.g., an embodiment may encrypt a 3D design in a GREG file (e.g., encrypt an STL file in a GREG file) and leave the rest of the content in the GREG file open or unencrypted or the embodiment may encrypt a 3D design in a GREG file, the tokens in the GREG file and any LEO file included in the GREG file.

Accordingly, an embodiment may selectively encrypt at least some of the content in a LEO or GREG file, and/or an embodiment may encrypt a GREG or LEO file as a whole. For example, an embodiment may encrypt an entire LEO or GREG file such that without a key the GREG or LEO file is useless but in other cases or configurations an embodiment may encrypt some of the content in a GREG or LEO file and leave some of the content in the GREG or LEO file unencrypted (or open as referred to in the art). For example, an embodiment may encrypt a digital representation of a 3D design in GREG file 810 (e.g., an STL file as described) but leave unprotected information 865, tokens 840 and/or GREG-level data 860 in GREG file 810 unencrypted or open. For example, leaving tokens 840 unencrypted may enable a user to know how many items can be manufactured using GREG file 810 but to actually manufacture the items, the user needs to receive a decryption key, e.g., after paying the owner of a design as described.

As described, content in a GREG or LEO file may include a 3D design, but may include other data such as unprotected information 865 and/or GREG-level data 860 (e.g., in GREG file 810 as shown), and thus encrypting content in some cases may include encrypting only a 3D design in the content of a GREG or LEO file while in other cases, encrypting content may include encrypting any or all of the content in a LEO or GREG file. Certain data may be external to a GREG or LEO file; e.g. a 3D design and tokens may be stored externally, e.g. in a database, with a link, pointer or reference to the design or its location stored in the GREG or LEO file.

An embodiment may further associate a plurality of tokens with some of one or more 3D design representations in a GREG or LEO file, wherein each of the tokens is used to enable at least one of: (a) a manufacturing device to perform one or more manufacturing steps for the item and (b) a software program to perform a manufacturing step related to at least one representation of the item. For example, to allow a user to manufacture one doll or toy truck, a GREG file may include one token and to allow a user to manufacture twelve toy trucks, a GREG or LEO file may include twelve tokens.

In some embodiments, e.g., in order to limit or control the number of copies of an item that can, or are allowed to be made based on a design, upon performing a manufacturing step for the item, an embodiment may delete, or mark as deleted or used, one or more of the tokens of a GREG or LEO file or an embodiment may decrement a counter associated with a token, e.g., tokens may be deleted or marked as deleted or used in server 120 or counters may be decremented in server 120 or in web services 230. For example, in the above case where twelve toy trucks are allowed to be made, a LEO or GREG file provided to a user may be linked or associated with twelve relevant tokens (which may be called truck-tokens), before enabling a user to manufacture a toy truck, an embodiment may check whether or not the GREG file has any truck-tokens (e.g., includes a pointer to truck-tokens in server 120) and, if no truck-tokens are found for the GREG file (or all tokens found are marked as used or as deleted) then an embodiment may prevent the user from manufacturing an additional toy truck. If the user's GREG or LEO has (or is associated with) a truck-token (or some associated tokens are available, that is, they are not marked as used or as deleted) then an embodiment may enable or permit the user to manufacture an additional toy truck and, possibly upon verifying successful completion of a manufacturing step, an embodiment may delete one truck-token for the user's GREG or LEO file (e.g., a token stored in server 120 and pointed to by the GREG file may be deleted). Consequently, the number of available tokens associated with a GREG or LEO file and the deletion or marking of tokens (or decrementing of counters as described) as items are manufactured enables embodiments to control the number of items that can, or are allowed to be made. Of course, more than one token may be deleted or marked as used or as deleted, during a single step or phase, for example, a number of tokens of a GREG file may be deleted, e.g., tokens of a plurality of items in a print bed may be deleted after a successful run of the print bed.

As described, embodiments of the invention may control the number of items that a user (e.g., a manufacturer) can, or is allowed to, make, e.g., based on the number of tokens in a GREG or LEO provided to the user. In some cases, having used all the tokens in a GREG or LEO file, a manufacturer may want to manufacture additional copies. In such case, a new GREG or LEO file may be created and provided to the user, however, creating a new file each time a user wants to make more copies of an item may be costly, e.g., in the case where a GREG file is an aggregation of many GREG or LEO files as described. In some embodiments, an automated replenishment procedure solves this problem as described.

Some embodiments may perform an automated replenishment procedure that may include replenishing, restoring or renewing a hierarchy of GREG files and/or LEO files and/or GREG/LEO tokens. For example, assuming a user has used all the tokens in a GREG or LEO file as described, e.g., the number of allowed copies of a product was reached and there are no more tokens left, the user may request (and probably pay for) an additional set of copies s/he wants to manufacture. In such case, if a request is granted, an embodiment may perform a replenishment procedure that may restore, assign, associate, clone, or replenish a hierarchy of tokens in GREG or LEO files such that tokens required for enabling the user to manufacture the requested additional set of copies are available. An automated replenishment procedure may avoid the need to create new or additional GREG or LEO files as further described herein.

A replenishment procedure may restore, assign, link, create, and/or modify tokens and/or counters in a database. For example, in order to enable a user to manufacture additional items (the manufacturing of which is controlled by tokens or counters as described) a counter of the relevant token, in server 120 or web services 230, may be incremented, duplicated or cloned in an automated replenishment procedure as described herein. In another example, a new or additional token in database 731 may be associated with a LEO file to thus enable manufacturing an additional item. Accordingly, an automated replenishment procedure may enable additional items to be made without replacing, modifying or even accessing GREG or LEO files on the client side.

An automated replenishment procedure performed by embodiments of the invention may include duplicating, recreating or cloning one or more tokens and/or counters. An automated replenishment procedure performed by embodiments of the invention may include duplicating or cloning a set of, possibly connected, linked, associated or related tokens and/or counters. For example, in an automated replenishment procedure, an entire hierarchy of tokens (e.g., as shown in token space in FIG. 9) may be restored to a predefined state by using available tokens or by duplicating, cloning, copying or creating tokens.

For example, an embodiment for controlling manufacturing, printing or producing items may encrypt at least some of the content in a LEO and/or GREG file, e.g., a 3D design representation of an item in a LEO and/or GREG file may be encrypted as described. An embodiment may associate a token with the 3D design representation, e.g., a token used to enable a manufacturing device to perform a step or to enable a software program to perform a manufacturing step may be associated with the 3D design representation. As described, a token may permit a limited number of steps to be performed, e.g., a token may allow a user to print one copy of doll. In some cases, having used a token for manufacturing an item (or a copy of an item) and wanting to manufacture an additional item, a user may request permission for manufacturing one or more items. Based on limitations received from an owner of a design and/or based on additional limitations as described, a request may be refused or the request may be granted. Upon granting a request for manufacturing an item or for performing an additional step related to the item, an embodiment may perform an automated replenishment procedure. An automated replenishment procedure may include adding or associating at least one token to at least one LEO or GREG file. For example, staying with the above doll example, following a replenishment procedure, a token may be associated with, or added to, a LEO file, thus producing a modified or replenished LEO file, and the user may use the modified or replenished LEO file to print an additional doll.

For example, referring to FIG. 9, assuming a user used two tokens in tokens 950 and one of tokens 960 and now wants additional tokens 950, an automated replenishment procedure may traverse the hierarchy starting at token 970 and add tokens where needed, e.g., an automated procedure may add one token 960 and two tokens 950. Accordingly, an automated replenishment procedure may receive, as input, a GREG or LEO file or even a token (that may be one of many tokens in the GREG or LEO file) and the automated replenishment procedure carried by an embodiment may replenish a hierarchy of GREG or LEO files and/or tokens where the input GREG file, LEO file or token is the top of the hierarchy, e.g., given GREG-3 930 as input, an embodiment may replenish, restore or reinstate GREG files, LEO files and tokens from GREG-3 930 and token 970 all the way down to LEO files 911 and 912, GREG file 913 and tokens 950.

Generally, an automated replenishment procedure may add tokens to GREG or LEO files or may associate tokens with existing GREG or LEO files such that additional items or copies can (or are allowed to) be made. For example, assuming the token 950 of LEO-1.0 911 has been used and a request for an additional token 950 for LEO-1.0 911 has been granted, an automated replenishment procedure may add a token 950 to LEO-1.0 911 such that the resulting or modified LEO-1.0 911 includes a token 950. Of course, any number of tokens at any level of a hierarchy as shown in FIG. 9 may be added by an automated replenishment procedure as described.

An automated replenishment procedure may be performed for and according to a print bed. For example, upon granting a request to print some or even all of the items or elements in a print bed, an embodiment may identify or determine the set of GREG or LEO files (and their respective tokens) which are related to the print bed, the embodiment may check for missing tokens in the set and may replenish or restore tokens as needed such that another run of the print bed is enabled. Accordingly, an automated replenishment procedure may be carried out for a single item, for a print bed or for a selected set of items.

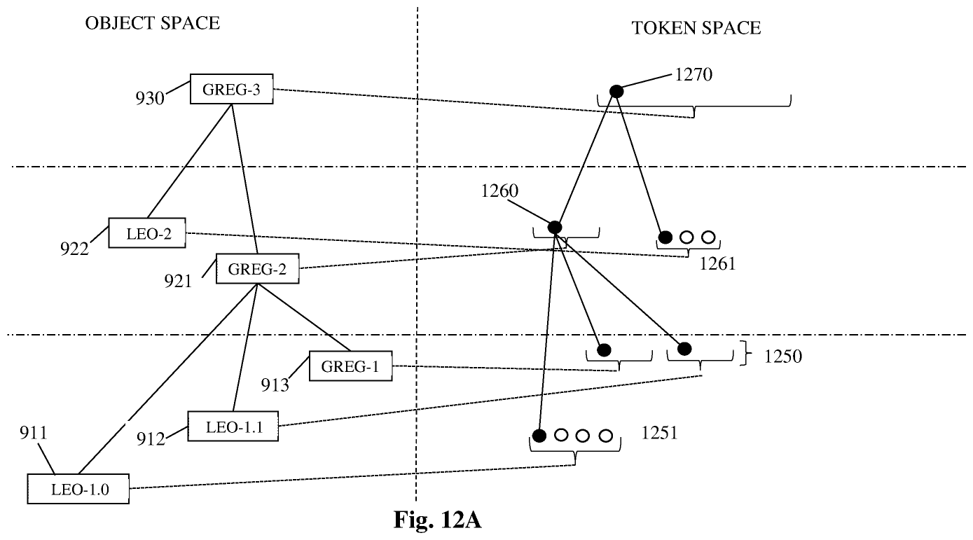

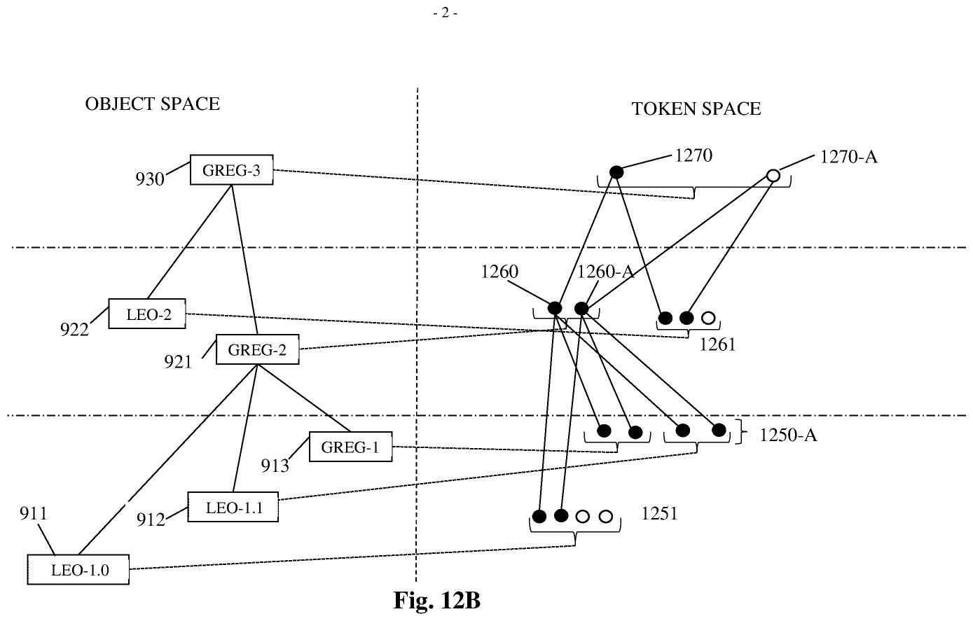

Reference is made to FIGS. 12A and 12B which illustrate a state (in terms of associated tokens) of a set of GREG and LEO files and associated tokens before (FIG. 12A) and after (FIG. 12B) an automated replenishment procedure according to some embodiments of the invention. As shown by FIG. 12A, tokens 1250 of GREG-1 913 and LEO-1.1 912 may be associated with token 1260 of GREG-2 921. As further shown, LEO-1.0 may include, or be associated with, four tokens 1251 one of which (shown as a black filled circle for clarity) may be associated with token 1260 of GREG-2 921 and may accordingly be marked as used. For example, associated with tokens 1250 and one of tokens 1251, token 1260 can represent tokens 1250 and the one of tokens 1251, e.g., token 1260 may be used for allowing or preventing a manufacturing step related to items which are controlled by tokens 1250 and the one of tokens 1251 as described. For example, token 1260 may be used for manufacturing items linked or associated with tokens 1250 and one of tokens 1251. As further shown, token 1270 may be linked or associated with token 1260 and one of tokens 1261 of LEO-2.

For example, a GREG or LEO file may include, or be associated with, more than one token of the same type, e.g., if a user has purchased the right to manufacture more than one copy of an item. For example, assuming LEO-1.0 911 includes a design of a toy-truck, if a user paid for four copies of the toy-truck than LEO-1.0 may include, or be associated with, four tokens as shown by tokens 1251, each enabling manufacturing the toy-truck. Similarly, and as illustrated in FIG. 12A, LEO-2 922 may include, or be associated with, three tokens, each enabling a manufacturing step, e.g., printing or manufacturing an item according to a design in LEO-2 922.

In some embodiments, when a token is associated with, or linked to, another token it is marked as used or mark for deletion as described. For example, the token shown by as a black filled circle in tokens 1251 is associated with token 1260 and is marked as used, however, the three remaining tokens in the set shown by 1251 are still available for use (shown as circles for clarity in FIG. 12A). Assuming a user has used token 1270, e.g., to print a print bed that includes items represented by, or linked with, tokens 1250, one of tokens 1251 and one of tokens 1261 and the user now wants to print an additional print bed with the same items, an automated replenishment procedure may be performed such that the entire hierarchy starting with token 1270 and shown in FIG. 12A is created, cloned, duplicated or recreated.

As shown by FIG. 12B, to restore or recreate a hierarchy of a token space (without having to create new GREG or LEO files) an embodiment may examine LEO-1.0 911, discover that although one of tokens 1251 was already used (e.g., marked as used), and that there remain three available tokens in, or associated with, LEO-1.0 911. Accordingly and as shown in FIG. 12B, one of the available tokens may be associated with a newly created token 1260-A of GREG-2 921. New token 1260-A may be created since GREG-2 921 does not include (or is not associated with) any spare tokens as do LEO-1.0 911 and LEO-2 922. Since, unlike LEO-1.0, GREG-1 913 and LEO-1.1 do not include (or are not associated with) any spare tokens, an automated replenishment procedure may create new tokens for these files, e.g., new tokens which are similar to the ones shown by tokens 1250 in FIG. 12A may be created (e.g., by duplicating or cloning the tokens in the set shown by 1250) to thus produce a new set of tokens 1250-A as shown in FIG. 12B. It is noted that (as illustrated by token sets 1250-A) the new set of tokens 1250-A may include the already used tokens and the new tokens, for example, following an automated replenishment procedure, GREG-2 921 which was associated with one token as shown in FIG. 12A may be associated with two tokens as shown by tokens 1250-A.

Creating, duplicating or cloning tokens in an automated replenishment procedure may be based on rules and restrictions provided for each item (or by an active or automated replenishment of these LEOs and GREGs by their respective owners). For example, creating a new token for LEO-1.1 912 may only be done if an owner of a design included in LEO-1.1 912 has agreed that additional items will be made based on his/her design. Any other rules or criteria may be observed by an embodiment when duplicating, cloning or recreating tokens in an automated replenishment procedure.

As further illustrated in FIG. 12B, one of the spare, free or available tokens 1261 of LEO-2 922 may be assigned to new token 1270-A and, as illustrated by the black filled circle, the newly assigned token may be marked as used. Accordingly, a set or hierarchy of tokens as shown by FIG. 12B created by an automated replenishment procedure may be similar to an original set or hierarchy of tokens, for example, following an automated replenishment procedure, the print bed that can be printed based on the hierarchy shown in FIG. 12A can be printed by the hierarchy shown in FIG. 12B. Otherwise described, the hierarchy starting at token 1270-A, which is produced by an automated replenishment procedure is a duplicate or clone of the hierarchy starting at token 1270. It is noted that an automated replenishment procedure as illustrated by FIGS. 12A and 12B may be performed without modifying or even accessing GREG or LEO files stored in a client's system. For example, cloning the hierarchy of tokens as shown by FIGS. 12A and 12B and described herein may be done by creating and linking tokens in database 731.

It will be noted that by creating (and associating) new tokens and/or by allocating or using existing free or available tokens in an automated replenishment procedure as described, embodiments of the invention may enable users to repeat a manufacturing of items (or even entire print beds) without having to create or even modify GREG or LEO files stored on the client's premises. For example, the operations described herein with reference to FIGS. 12A and 12B, e.g., associating tokens 1251 with tokens 1260 and 1260-A may be performed by server 120 by manipulating tokens and their data in database 731.

In some embodiments, a plurality of tokens may be represented by a super-token. For example, instead of associating four tokens with LEO-1.0 as shown by FIG. 12A, a single super-token may be used. Controlling the number of items manufactured may be done using a super-token. For example, a super-token may include a reference, pointer or link to a list of tokens. For example, a super-token may include a reference to a list of tokens where each entry in the list includes data for a token, e.g., an entry for each token may indicate whether or not the token is available (or was used and thus is marked as used), when, where and by who the token was used, which GREG or LEO file the token is associated with, which tokens the token is associated with and so on. Accordingly, reducing the number of tokens in a set of tokens or marking tokens as used or marking them for deletion may be done via, or using, a super-token that is associated with the set of tokens.

Accordingly, an automated replenishment procedure performed by embodiments of the invention enables setting the content and/or state of GREG or LEO files, held by a user (e.g., in a storage of a manufacturer's system) to a desired content or state. For example, during an automated replenishment procedure, tokens may be added, linked or assigned to (possibly a hierarchy of) GREG and LEO files (e.g., stored in manufacturer computer 130 or in a manufacturing system 140) without having to create and/or provide new or additional GREG or LEO files. Of course, any other content in GREG or LEO files may be modified or updated in an automated replenishment procedure performed by embodiments of the invention, for example, materials that may or may not be used, permitted modifications and so on included in GREG or LEO files as described may all be modified or updated during an automated replenishment procedure.

As described, a GREG or LEO file may be created based on a set of one or more GREG or LEO files. For example, as shown in FIG. 10, one or more LEO and/or GREG files 1010 (and/or tokens in these files) may be provided as input to an embodiment and a set of one or more output LEO and/or GREG files and/or tokens 1020 may be provided as output. As further described, a reverse process may disaggregate or divide a single GREG or LEO file into two or more GREG or LEO files. Accordingly, embodiments of the invention enable aggregation and disaggregation of files or other objects such as GREG and LEO files and/or tokens. Such aggregation and disaggregation enable embodiments to provide full control of a production of items, e.g., control the number and way items are made, printed or manufactured, adhere to restrictions placed by an owner of a design and so on.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer or a server computer.

Unless explicitly stated, the method embodiments described herein are not constrained to a particular order or sequence. Additionally, some of the described method embodiments or elements thereof can occur or be performed at the same point in time. While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein.

What is claimed is:

1. A method of controlling manufacturing of items, the method comprising:
encrypting content in at least one limited edition object (LEO) file and associating at least one LEO token with at least one LEO file, wherein a LEO file includes at least one three-dimensional (3D) design representation of an item;
creating a first aggregated (GREG) file based on information in at least one of: a LEO file or a previously existing GREG file;
associating at least one aggregated (GREG) token with the GREG file and with at least one of: the at least one LEO token and a second GREG file; and
using at least one GREG token, by a server, to enable at least one of: (a) a manufacturing device to perform one or more manufacturing steps for an item and (b) a software program to perform a manufacturing step related to at least one design representation of an item.

2. The method of claim 1, comprising:
determining, based on the at least one GREG token, a respective set of design characteristics of a respective set of items; and
determining whether or not a manufacturing step can be performed for the entire set of items.

3. The method of claim 1, comprising:
receiving a definition of a manufacturing step; and
identifying a group of items that can be processed together by the manufacturing step.

4. The method of claim 1, comprising creating, based on a first GREG file or a LEO file, a second GREG file, the second GREG file associated with at least one representation of at least one item represented in the first GREG file or in the LEO file.

5. The method of claim 1, comprising:
recording information related to usage of data associated with the GREG file; and
associating the recorded information with the GREG token or GREG file.

6. The method of claim 1, wherein the GREG token is usable for at least one of: selecting, enabling and controlling at least one of: a pre-processing manufacturing step and a post-processing manufacturing step.

7. The method of claim 1, wherein the GREG token is usable for at least one of: controlling the number of item copies manufactured and retrieving, from a storage device, at least one of: a LEO token and a second GREG token.

8. The method of claim 1, comprising including in the GREG file unprotected information.

9. The method of claim 1, comprising:
associating a token with the 3D design representation, wherein the token is used to enable at least one of: (a) a manufacturing device to perform one or more manufacturing steps for the item and (b) a software program to perform a manufacturing step related to at least one representation of the item; and
upon granting a request for performing an additional step related to the item, performing a replenishment procedure, the replenishment procedure comprising associating at least one token with at least one of the LEO file and the GREG file.

10. The method of claim 1, comprising:
associating a plurality of tokens with the 3D design representation, wherein each of the tokens is used to enable at least one of: (a) a manufacturing device to perform one or more manufacturing steps for the item and (b) a software program to perform a manufacturing step related to at least one representation of the item; and
upon performing a manufacturing step for the item, performing at least one of: deleting one or more of the tokens and marking as used one or more of the tokens.

11. The method of claim 1, comprising:
associating a set of tokens with the 3D design representation, wherein each of the tokens is used to enable at least one of: (a) a manufacturing device to perform one or more manufacturing steps for the item and (b) a software program to perform a manufacturing step related to at least one representation of the item; and
disaggregating the set of tokens by associating a first subset of the set with a first GREG or LEO file and associating a second subset of the set with a second GREG or LEO file.

12. A method of aggregating 3D digital assets, the method comprising:
encrypting content in at least one limited edition object (LEO) file and associating at least one LEO token with at least one LEO file, wherein a LEO file includes at least one three-dimensional (3D) digital asset related to an item;
creating a first aggregated (GREG) file based on information in at least one of: a LEO file and an existing aggregated (GREG) file;
associating at least one aggregated (GREG) token with the GREG file and with at least one of: the at least one LEO token and a second GREG file;
using at least one GREG token, by a server, to control a manufacturing step related to at least one of the digital assets.

13. A system for controlling manufacturing of items, the system comprising:
a memory; and
a controller configured to:
encrypt content in at least one limited edition object (LEO) file and associating at least one LEO token with at least one LEO file, wherein a LEO file includes at least one three-dimensional (3D) design representation of an item;
create a first aggregated (GREG) file based on information in at least one of: a LEO file or a previously existing GREG file;
associate at least one aggregated (GREG) token with the GREG file and with at least one of: the at least one LEO token and a second GREG file; and
use at least one GREG token, by a server, to enable at least one of: (a) a manufacturing device to perform one or more manufacturing steps for an item and (b) a software program to perform a manufacturing step related to at least one representation of an item.

14. The system of claim 13, wherein the controller is configured to:
determine, based on the at least one GREG token, a respective set of design characteristics of a respective set of items; and
determine whether or not a manufacturing step can be performed for the entire set of items.

15. The system of claim 13, wherein the controller is configured to:
receive a definition of a manufacturing step; and
identify a group of items that can be processed together by the manufacturing step.

16. The system of claim 13, wherein the controller is configured to create, based on a first GREG file or a LEO file, a second GREG file, the second GREG file associated with at least one representation of at least one item represented in the first GREG file or in the LEO file.

17. The system of claim 13, wherein the controller is configured to:
record information related to usage of data associated with the GREG file; and
associate the recorded information with the GREG token or GREG file.

18. The system of claim 13, wherein the GREG token is usable for at least one of: selecting, enabling and controlling at least one of: a pre-processing manufacturing step and a post-processing manufacturing step.

19. The system of claim 13, wherein the GREG token is usable for controlling the number of item copies manufactured.

20. The system of claim 13, wherein the GREG token is usable for retrieving, from a storage device, at least one of: a LEO token and a second GREG token.
